(19) United States
(12) Patent Application Publication
(10) Pub. No.: US 2009/0063981 A1
(43) Pub. Date: Mar. 5, 2009

(54) DISPLAY CONTROL APPARATUS AND CONTROL METHOD THEREOF, PROGRAM, AND RECORDING MEDIUM

(75) Inventors: Toru Kikuchi, Hino-shi (JP); Motoki Nakama, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/194,439

(22) Filed: Aug. 19, 2008

(30) Foreign Application Priority Data
Sep. 3, 2007 (JP) 2007-228285
Sep. 3, 2007 (JP) 2007-228286

(51) Int. Cl. G06F 3/00

(52) U.S. Cl. 715/723

(57) ABSTRACT

A display control apparatus for displaying an image included in an array of images on a display unit, includes: a display control unit adapted to display a scroll area corresponding to an order of images in the array on the display unit; an accepting unit adapted to accept selection of a first image included in the array in response to a user's scroll operation; and an acquisition unit adapted to acquire a plurality of second images from images in at least one of ranges before and after the first image, wherein the display control unit displays the first image and the plurality of second images on the display unit, and the acquisition unit switches an acquisition method of the second images based on a characteristic of the scroll operation.

### BACKGROUND OF THE INVENTION

1. Field of the Invention

The present invention relates to a display control apparatus and control method thereof, a program, and a recording medium and, more particularly, to a technique for allowing the user to easily retrieve a desired image from an array of images, and a technique for displaying thumbnails of frames included in a moving image.

2. Description of the Related Art

In recent years, digital home electric appliances such as digital cameras, digital video cameras, digital video disk recorders, flat-screen television receivers, and the like have prevailed increasingly. These digital home electric appliances allow users to create and browse contents data such as still images, moving images, and the like. When the television receiver (to be referred to as a TV hereinafter) cooperates with a personal computer (to be referred to as a PC hereinafter) via a set-top box, home game machine, or the like, the user can browse contents data such as moving image data and the like stored in the PC on the TV.

Upon browsing contents data using a digital home electric appliance, it is required to allow simple user's operations. Hence, an arrangement that sequentially displays thumbnail images of contents based on operations of keys or the like, and plays back a corresponding content in response to selection of a thumbnail image is known (see Japanese Patent Laid-Open No. 2001-312350).

As an arrangement that organizes contents data, an arrangement which categorizes contents based on a user's operation instruction, forms a directory used to store the contents based on the categories, and stores the contents in this directory is known (see Japanese Patent Laid-Open No. 8-63485). In this arrangement, the contents are hierarchically managed, and a management unit in upper layers is called “album”. Directory layers used to store the contents correspond to layers used to manage the contents, and albums correspond to upper directories in the directory layers. In this way, this arrangement manages contents associated with images by combining them as albums, and allows the user to select desired data by selecting an album and an index image in the selected album.

Also, as an arrangement that allows the user to select an arbitrary scene in a moving image and to play back and display the selected scene, an arrangement which hierarchically divides the entire moving image into short frame sequences according to its configuration and semantic contents, and displays still images of representative frames of respective frame sequences is known (see Japanese Patent Laid-Open No. 5-282379). According to this arrangement, the user can confirm the contents of each frame sequence by referring to the still image of the representative frame.

However, in recent years, along with capacity enhancements and cost reductions of recording media, the number of stored contents and video recording times of moving images tend to increase. When the number of contents and video recording times increase, the user needs to confirm a large number of thumbnail images to select a desired content in the arrangement based on scrolling (Japanese Patent Laid-Open No. 2001-312350).

In the arrangement using album-basis management (Japanese Patent Laid-Open No. 8-63485), when the user cannot determine based on attribute information such as album names and the like whether or not each album includes a desired content, he or she needs to open albums one by one to confirm index images. In other words, in order to facilitate contents browsing operations, the user needs to appropriately classify contents to albums. Therefore, with this arrangement, an operation load on the user in at least one of the contents classification operation and browsing operation is heavy.

In the arrangement that hierarchically divides the entire moving image (Japanese Patent Laid-Open No. 5-282379), upon displaying representative frames of an upper layer in which the number of scenes to be displayed is small, scene granularity becomes coarse. For this reason, it is difficult for the user to recognize based on the representative frames whether or not a desired scene is included. Therefore, the user needs to repetitively check between the upper layer and the recognizable lower layer while confirming representative frames or to confirm representative frames in the lower layer one by one from the beginning.

The aforementioned related arts have poor operability since they require the user to make many decisions or operations.

Along with performance enhancements and cost reductions of digital devices such as digital cameras, digital video cameras, mobile phones, and the like, and capacity enhancements of storages equipped in these devices, even personal users can easily record moving image data. As a result, personal users possess a huge variety and volume of moving image data. In such situations, needs to easily recognize the whole picture of each individual moving image data within a short period of time and needs to quickly retrieve and play back a desired scene in moving image data are increasing.

Conventional scene retrieval in moving image data is generally attained by playback from the beginning and sequential retrieval by fastforwarding. However, scene retrieval to retrieve a desired scene is time-consuming and troublesome for the user.

As another prevalent retrieval method, a plurality of frames (still images) are extracted from moving image data as index frames, and are index displayed as chapters or representative scenes to allow the user to retrieve a desired scene.

However, index frames used in such index display are frames selected by a moving image data producer or fixed frames which are automatically selected by various image processing techniques. For this reason, such index frames do not always match a moving image frame (or scene) that the user wants. As a result, it is often difficult to easily recognize the full picture of moving image data within a short period of time or to quickly retrieve a desired moving image frame based only on displayed index frames.

In order to solve such problems, an arrangement that allows the user to change frames to be extracted from moving image data, and improves operability when the user retrieves and plays back a desired moving image frame is known (Japanese Patent Laid-Open Nos. 2006-279267 and 2006-186617). In these arrangements, frames to be extracted from moving image data are hierarchized based on their extraction time intervals, and the layer (time interval) is switched by a simple operation, thereby arbitrarily changing and displaying index frames that represent the contents of the image data.

However, in the arrangements of Japanese Patent Laid-Open Nos. 2006-279267 and 2006-186617, when the user shortens the time interval of index frames to be displayed by, for example, making a zoom-in operation or the like for zooming in index frames displayed in a list, only some frames of moving image data are displayed on the screen. In order to recognize the entire moving image again the user needs to make, for example, a zoom-out operation to display index frames at a long time interval again. As a result, the user needs to repeat switching of layers (zoom-in and zoom-out) until he or she can reach a target moving image frame, resulting in troublesome user's operations.

### SUMMARY OF THE INVENTION

The present invention has been made in consideration of the aforementioned problems, and has as its object to provide an image browsing technique with high operability. Also, the present invention has as its object to provide a technique that allows the user to recognize the contents of the entire moving image data by a simple operation.

According to one aspect of the present invention, a display control apparatus for displaying an image included in an array of images on a display unit, comprises:

a display control unit adapted to display a scroll area corresponding to an order of images in the array on the display unit;

an accepting unit adapted to accept selection of a first image included in the array in response to a user's scroll operation; and

an acquisition unit adapted to acquire a plurality of second images from images in at least one of ranges before and after the first image,

wherein the display control unit displays the first image and the plurality of second images on the display unit, and

the acquisition unit switches an acquisition method of the second images based on a characteristic of the scroll operation.

According to another aspect of the present invention, a method of controlling a display control apparatus for displaying an image included in an array of images on a display unit, comprises the steps of:

displaying a scroll area corresponding to an order of images in the array on the display unit;

accepting selection of a first image included in the array in response to a user's scroll operation;

acquiring a plurality of second images from images in at least one of ranges before and after the first image; and

displaying the first image and the plurality of second images on the display unit,

wherein in the step of acquiring the second images, an acquisition method of the second images is switched based on a characteristic of the scroll operation.

According to still another aspect of the present invention, a display control apparatus for displaying thumbnails of frames included in a moving image on a display unit, comprises:

an accepting unit adapted to accept selection of a first frame included in the moving image;

an acquisition unit adapted to acquire a plurality of second frames from frames in at least one of ranges before and after the first frame; and

a display control unit adapted to display a thumbnail of the first frame and thumbnails of the plurality of second frames on the display unit,

wherein the acquisition unit acquires the second frames to broaden a frame interval between neighboring frames of the first frame or the plurality of second frames as the neighboring frames are separated farther away from the first frame.

According to yet another aspect of the present invention, a method of controlling a display control apparatus for displaying thumbnails of frames included in a moving image on a display unit, comprises the steps of:

accepting selection of a first frame included in the moving image;

acquiring a plurality of second frames from frames in at least one of ranges before and after the first frame; and

displaying a thumbnail of the first frame and thumbnails of the plurality of second frames on the display unit,

wherein in the step of acquiring the second frames, the second frames are acquired to broaden a frame interval between neighboring frames of the first frame or the plurality of second frames as the neighboring frames are separated farther away from the first frame.

Further features of the present invention will become apparent from the following description of exemplary embodiments with reference to the attached drawings.

### BRIEF DESCRIPTION OF THE DRAWINGS

FIG. 1 is a block diagram showing the hardware arrangement of an image browsing apparatus;

FIG. 2 is a block diagram showing the functional arrangement of the image browsing apparatus;

FIG. 3 is a view showing an example of moving image frame information;

FIG. 4 is a view showing an example of a user interface screen;

FIG. 5 is a view showing another example of the user interface screen;

FIG. 6 is a view showing an example of an infrared remote controller;

FIGS. 7A and 7B are flowcharts showing the sequence of main processing of the image browsing apparatus;

FIG. 8 is a view showing an example of the user interface screen upon left scrolling;

FIG. 9 is a view showing an example of the user interface screen upon left scrolling;

FIG. 10 is a view showing an example of the user interface screen upon right scrolling;

FIG. 11 is a view showing an example of the user interface screen upon right scrolling;

FIGS. 12A and 12B are flowcharts showing the sequence of main processing of the image browsing apparatus;

FIG. 13 is a block diagram showing the functional arrangement of an image browsing apparatus;

FIG. 14 is a view showing an example of the user interface screen upon left scrolling;

FIG. 15 is a view showing an example of the user interface screen upon left scrolling;

FIGS. 16A, 16B, and 16C are flowcharts showing the sequence of main processing of the image browsing apparatus;

FIG. 17 is a view showing a basic system arrangement of a moving image display apparatus;

FIG. 18 is a block diagram showing the hardware arrangement of the moving image display apparatus;

FIG. 19 is a block diagram showing the functional arrangement of the moving image display apparatus;

FIG. 20 is a view showing an example of an operation input device used to operate the moving image display apparatus;

FIG. 21 is a flowchart showing the main sequence of surveying index display processing;

FIG. 22 is a view for explaining an algorithm for creating an index screen;

FIG. 23 is a flowchart showing the sequence of index screen creation processing;

FIG. 24 is a flowchart showing the sequence of index screen creation processing;

FIG. 25 is a flowchart showing the processing sequence of initialization processing;

FIG. 26 is a flowchart showing the sequence of index frame generation processing;

FIG. 27 is a view showing an example of an initial index display screen;

FIG. 28 is a view showing an example of an index display screen;

FIG. 29 is a view showing an example of a screen display to be output;

FIG. 30 is a view showing an example of a screen display to be output; and

FIG. 31 is a view for explaining improvement of operability in moving image frame retrieval.

### DESCRIPTION OF THE EMBODIMENTS

Embodiments according to the present invention will be described in detail hereinafter with reference to the accompanying drawings. Note that components described in these embodiments are merely examples, and do not limit the scope of the present invention to only them. All combinations of features described in the embodiments of the present invention are not always indispensable to solving means of the present invention.

### First Embodiment

(Hardware Arrangement)

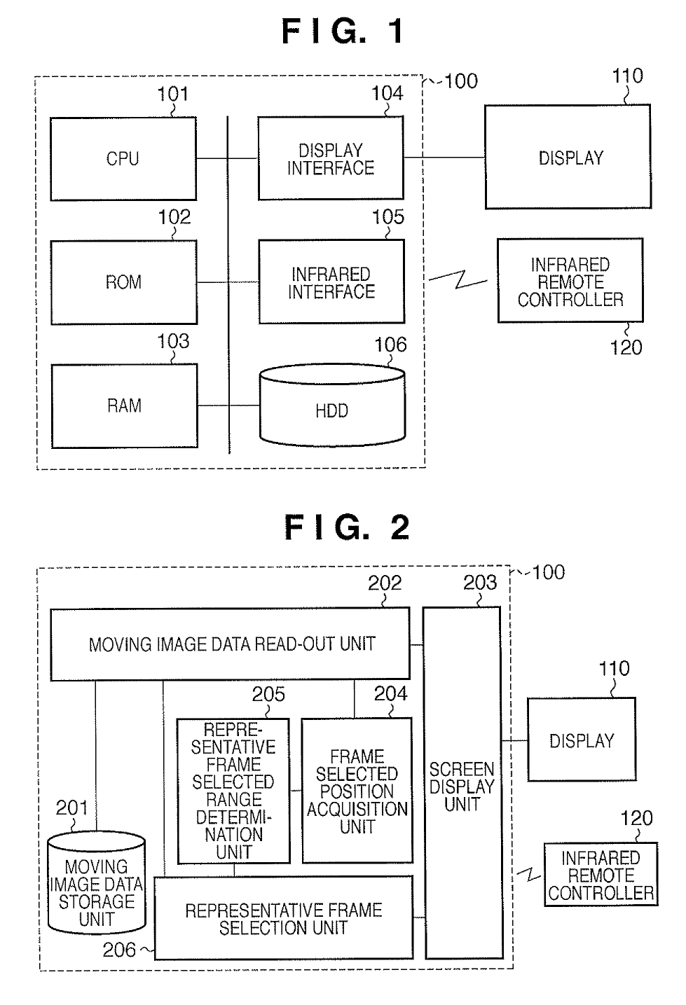

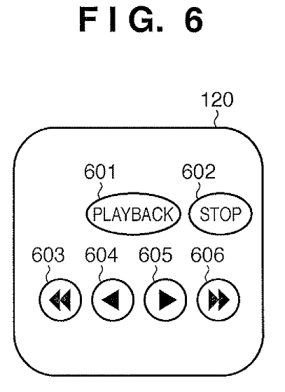

FIG. 1 is a block diagram showing the hardware arrangement of an image browsing apparatus (display control apparatus) according to the first embodiment. Referring to FIG. 1, reference numeral 100 denotes an image browsing apparatus; 110, a display such as a liquid crystal display, CRT display, or the like; and 120, an infrared remote controller, which will be described later with reference to FIG. 6. As shown in FIG. 1, the image browsing apparatus 100 comprises a CPU 101, ROM 102, RAM 103, hard disk drive (HDD) 106, infrared (input) interface 105, and display interface 104.

The CPU 101 executes application programs, an operating system (OS), control programs, and the like, which are stored in the HDD 106. The CPU 101 controls the RAM 103 to temporarily store information, files, and the like required to execute the programs.

The ROM 102 stores a boot program used to boot up the OS stored in the HDD 106 upon power-ON of the image browsing apparatus 100. The CPU 101 executes processing for booting up the OS based on this boot program. After the OS is booted up, processing programs according to this embodiment are read out from the HDD 106 and are executed. The ROM 102 also stores programs such as a basic I/O program and the like, and various data such as font data, template data, and the like used in basic processing.

The RAM 103 temporarily stores various data, and serves as a main memory, work area, and the like of the CPU 101.

The HDD 106 is an external storage device which serves as a large-capacity memory. The HDD 106 stores processing programs, various kinds of information, video data, device drivers, and the like.

The infrared input interface 105 receives an infrared signal from the infrared remote controller 120, and converts the received signal into information that can be processed by an infrared interface display device driver (not shown). The display interface 104 converts screen information from a display device driver (not shown) into a signal that can undergo display processing of the display 110, and outputs that signal to the display 110.

Note that software that can implement the functions equivalent to the aforementioned devices can implement the image browsing apparatus in place of hardware devices.

In this embodiment, the image browsing apparatus 100 is implemented by a set-top box. However, the image browsing apparatus 100 may be implemented by other digital home electric appliances such as a home game machine, digital video disk (DVD) player, DVD recorder, digital camera, digital video camera, flat-screen TV, and the like. Alternatively, the image browsing apparatus 100 may be implemented by information processing apparatuses such as a personal computer (PC), workstation, portable information terminal (PDA), and the like, a mobile phone, and electronic parts such as a semiconductor integrated circuit and the like.

In this embodiment, the HDD 106 is assumed as an external storage device which serves as a large-capacity memory. However, the present invention is not limited to this. For example, the external storage device may be implemented using media such as a flexible disk (FD), CD-ROM, CD-R, CD-RW, PC card, DVD, IC memory card, MO, and the like.

This embodiment will explain the arrangement that implements the image browsing apparatus 100 according to this embodiment by a single apparatus for the sake of simplicity. However, the image browsing apparatus 100 may be implemented by an arrangement that distributes resources to a plurality of apparatuses. For example, storage and arithmetic resources may be distributed to a plurality of apparatuses. Alternatively, resources may be distributed to components which are virtually implemented on the image browsing apparatus 100, and may undergo parallel processes.

Note that the same reference numerals denote the same components throughout the drawings unless otherwise specified, and a detailed description thereof will not be repeated.

(Functional Arrangement)

FIG. 2 is a block diagram showing the functional arrangement of the image browsing apparatus 100 according to this embodiment. As shown in FIG. 2, the image browsing apparatus 100 comprises functional blocks of a moving data storage unit 201, moving image data read-out unit 202, screen display unit 203, frame selected position acquisition unit 204, representative frame selection range determination unit 205, and representative frame selection unit 206.

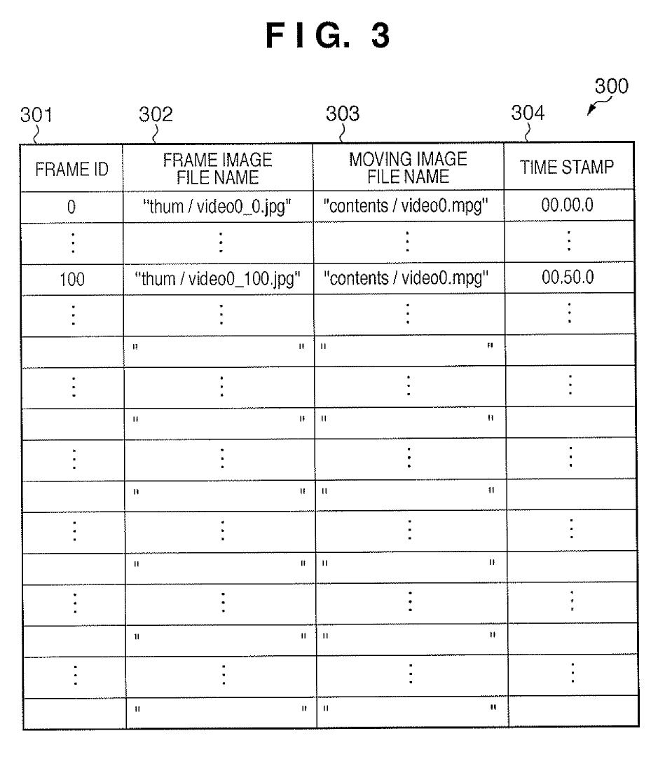

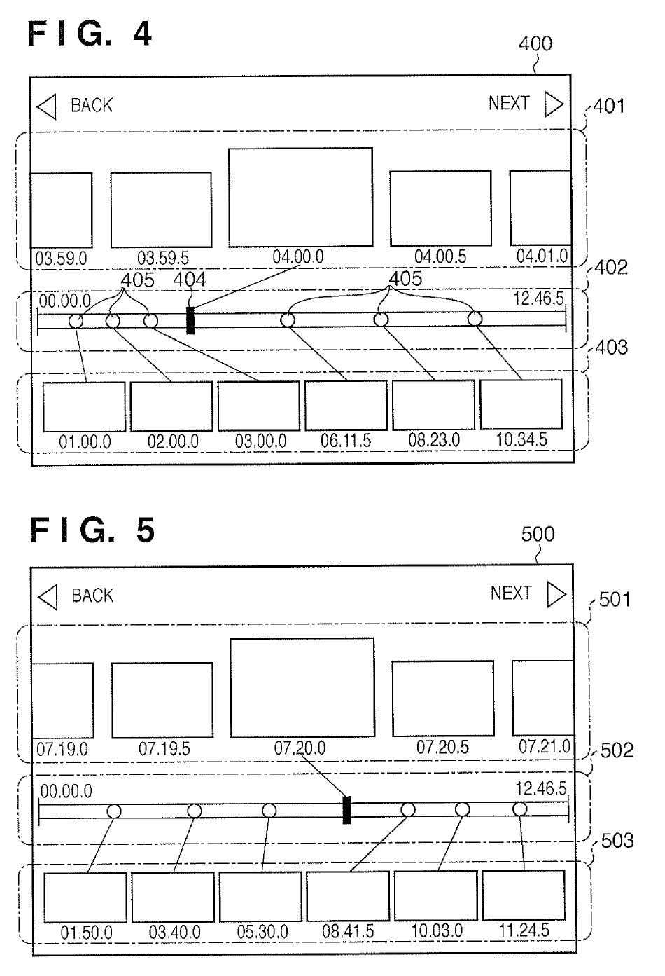

The moving image data storage unit 201 stores moving image data, moving image frame images, and moving image frame information 300, which will be described later with reference to FIG. 3, using the storage area of the HDD 106. The moving image data read-out unit 202 reads out the moving image frame information 300 and moving frame images (image array) based on the moving image frame information 300, and displays them on the display 110 via the screen display unit 203.

The screen display unit 203 displays a display screen on the display 110. For example, the screen display unit 203 displays user interface screens 400 and 500, which will be described later with reference to FIGS. 4 and 5, and displays moving image data read out via the moving image data read-out unit 202 based on an operation input from the infrared remote controller 120.

The frame selected position acquisition unit 204 acquires the frame selected position of frames which are read out by the moving image data read-out unit 202 and are sequentially displayed by the screen display unit 203. Note that the frame selected position is specified by the number of frames from the start frame.

The representative frame selection range determination unit 205 determines a selection range of representative frames (second images) based on the frame selected position acquired via the frame selected position acquisition unit 204. In this embodiment, two ranges, that is, a range from the start position of a moving image to the frame selected position, and a range from the frame selected position to the rearmost position of the moving image, are determined as representative frame selection ranges.

The representative frame selection unit 206 selects representative frames based on the representative frame selection ranges determined by the representative frame selection range determination unit 205. Then, the unit 206 displays, on the display 110, representative frame images, which will be described later with reference to FIGS. 4 and 5, via the screen display unit 203.

{Moving Image Frame Information}

FIG. 3 shows an example of moving image frame information according to this embodiment. As shown in FIG. 3, the moving image frame information 300 includes a frame ID 301, frame image file name 302, moving image file name 303, and time stamp 304.

The frame ID 301 is an ID used to uniquely identify a frame in identical moving image data, and the frame image file name 302 is a path name on the file system upon saving a corresponding frame as a still image file. The moving image file name 303 is a path name on the file system of moving image data to which the corresponding frame belongs, and the time stamp 304 is information which represents the frame position in the moving image data as a time.

For example, in the example of FIG. 3, a frame with the frame ID 301=100 is a frame at a time position of 50 sec of moving image data having a path name “contents/video0.mpg”. An image of this frame is a file having a path name “thum/video0_{—}100.jpg”.

The moving image data read-out unit 202 reads out image data based on the corresponding image file name by sequentially incrementing the frame ID, and scroll-displays the image data on the display 110 via the screen display unit 203. Upon reception of a moving image playback operation input from the infrared remote controller 120 via the screen display unit 203, the moving image data read-out unit 202 reads out moving image data of that moving image file name from a time stamp position, and cues and plays back the moving image data via the screen display unit 203.

Note that the moving image frame information 300 shown in FIG. 3 is an example, and the configuration of information, the number of frames, positions, file names, file format, and the like are not limited to those shown in FIG. 3.

(User Interface Screen)

FIG. 4 shows an example of a user interface screen in this embodiment. As shown in FIG. 4, a user interface screen 400 includes a scroll display area 401, indicator display area 402, and representative frame image display area 403.

The scroll display area (scroll area) 401 scroll-displays moving image frame images based on the moving image frame information 300, and the representative frame image display area 403 displays images of representative frames. That is, a scroll area corresponding to the order of images in the moving image is displayed. Note that “scroll display” is to sequentially display frame image by moving them to the right or left. In this embodiment, a frame located at the center on the scroll display area 401 is a selected frame (first image). That is, the image browsing apparatus 100 executes acceptance processing for accepting selection of a frame included in the moving image in response to a scroll operation by the user. The image browsing apparatus 100 starts playback from this frame in response to a playback operation.

The indicator display area 402 represents the whole moving image data as a horizontal band, and displays the position of the selected frame and those of representative frames in the whole moving image data. In the example of FIG. 4, an indicator 404 indicates the position of the selected frame, and indicators 405 indicate the positions of representative frames.

In FIG. 4, a frame at a time position of “04.00.0” of “12.46.5”-long moving image data is selected by scrolling. Also, frames at time positions of “01.00.0”, “02.00.0”, “03.00.0”, “06.11.5”, “08.23.0”, and “10.34.5” are selected as representative frames.

The representative frames are selected from the range from the start time position “00.00.0” to the frame selected position “04.00.0” and the range from the frame selected position “04.00.0” to the rearmost time position “12.46.5”, so as to have equal time intervals, respectively.

Note that the user interface screen 400 is an example, and the configuration, layout, and the like are not limited to those shown in FIG. 4.

FIG. 5 shows another example of the user interface screen according to this embodiment. As in FIG. 4, a user interface screen 500 includes a scroll display area 501, indicator display area 502, and representative frame image display area 503.

On the user interface screen 500, a frame at a time position of “07.20.0” is selected unlike the user interface screen 400. Also, frames at time positions of “01.50.0”, “03.40.0”, “05.30.0”, “08.41.5”, “10.03.0”, and “11.24.5” are selected as representative frames. On this screen, the representative frames are selected from the range from the start time position “00.00.0” to the frame selected position “07.20.0” and the range from frame selected position “07.20.0” to the rearmost time position “12.46.5” in correspondence with the change in frame selected position.

Note that the user interface screen 500 is an example, and the layout, and the like are not limited to those shown in FIG. 5.

(Remote Controller)

FIG. 6 shows an example of the infrared remote controller 120 according to this embodiment. As shown in FIG. 6, the infrared remote controller 120 has a left scroll button 605, right scroll button 604, left fast scroll button 606 used to instruct left fast scrolling, and right fast scroll button 603 used to instruct right fast scrolling. Note that “left scroll” is to scroll frame images on the scroll display area to the left, that is, to select a frame located at the right neighboring position on the display screen. Also, “right scroll” is an operation opposite to the “left scroll”. The infrared remote controller 120 has a playback button 601 used to give the instruction to start playback from the selected frame, and a (playback) stop button 602 used to give the instruction to stop playback.

Note that the infrared remote controller 120 of this embodiment is an example, and the button configuration, layout, button names, and the like are not limited to those shown in FIG. 6. In this embodiment, the infrared remote controller 120 accepts user's operation instructions. However, any other devices such as a keyboard, pointing device, touch panel, jog dial, and the like may accept user's operation instructions as long as they can accept user's operations. Also, a device that accepts user's operation instructions may be included in the same housing as the image browsing apparatus 100.

(Main Processing)

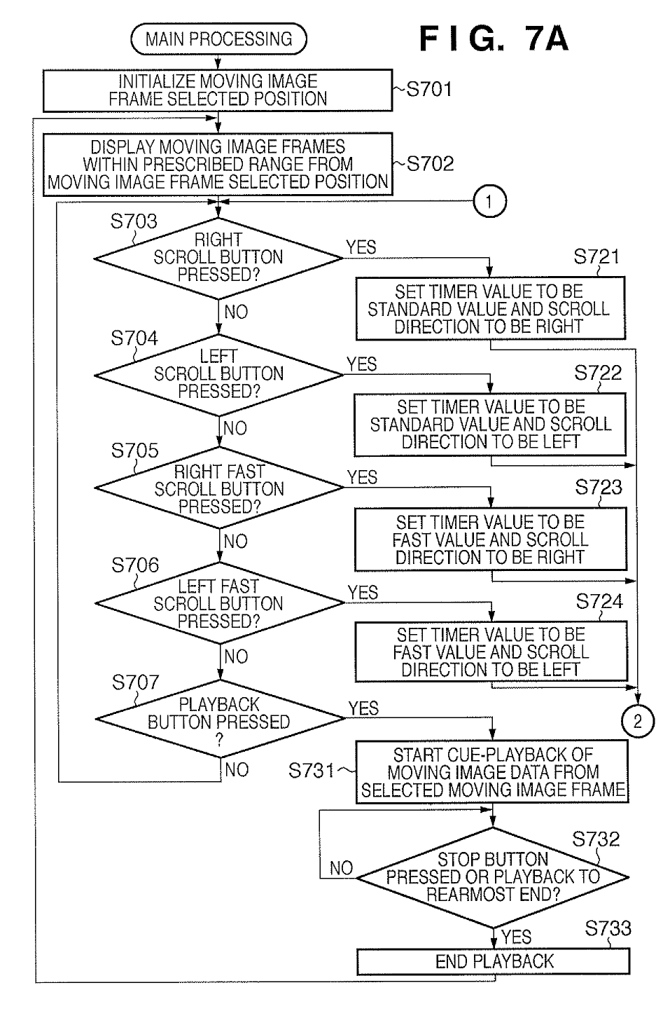

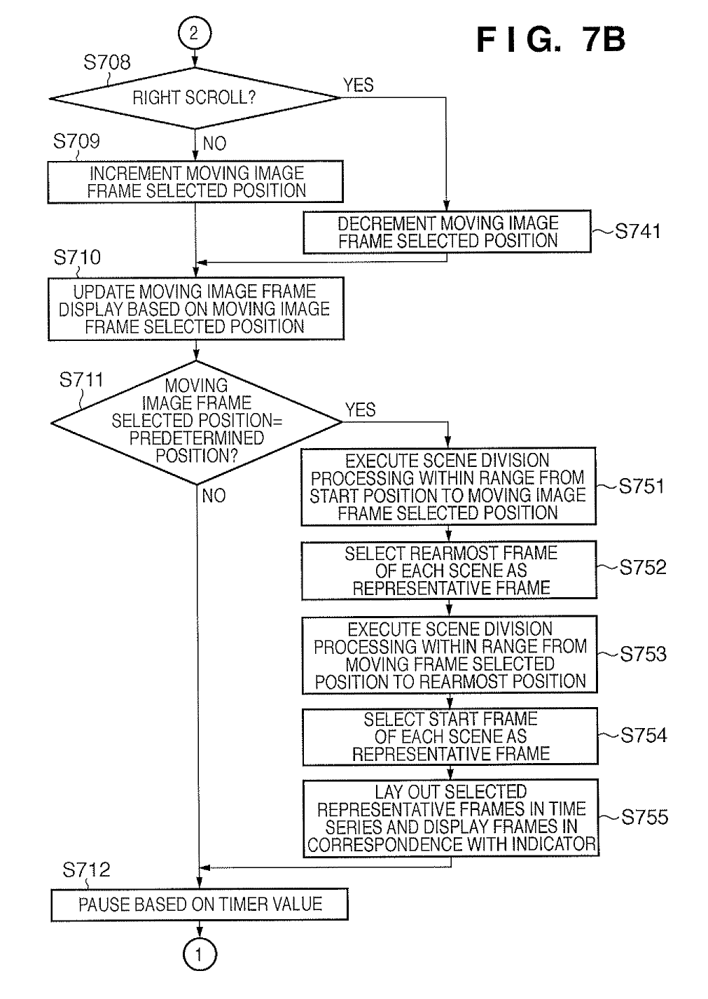

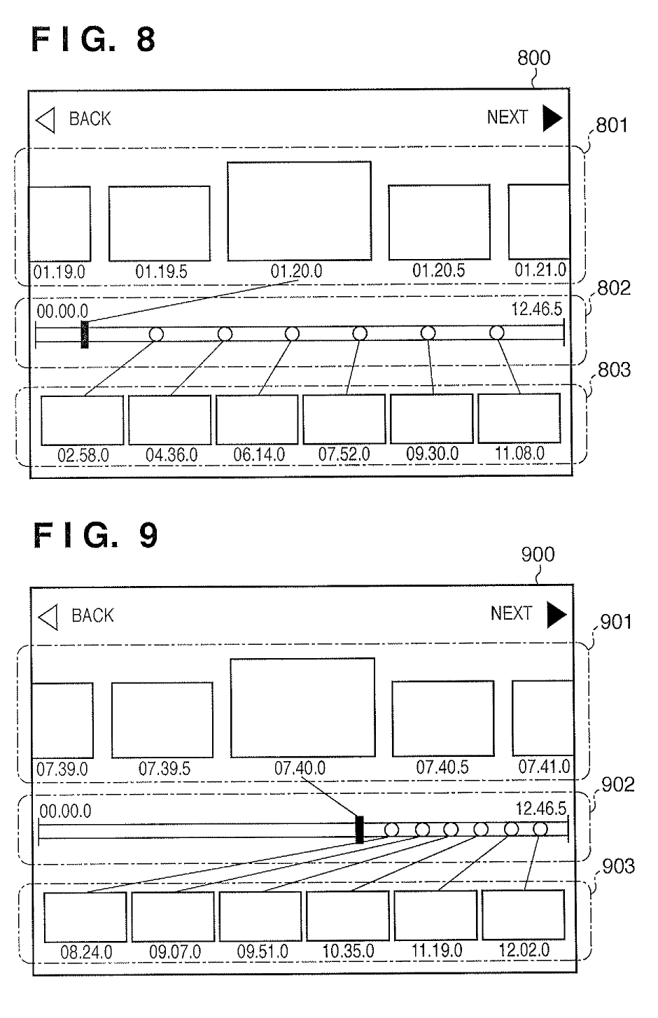

FIGS. 7A and 7B are flowcharts showing the sequence of main processing of the image browsing apparatus 100 of this embodiment. Respective steps of the sequence shown in FIGS. 7A and 7B are executed under the control of the CPU 101.

When the main processing starts, as shown in FIG. 7A, the CPU 101 initializes the moving image frame selected position (S701). In this case, the CPU 101 sets the frame ID to be zero.

The CPU 101 displays, on the scroll display area 401, frame images of frames within the ranges from the moving image frame selected position in accordance with the screen configurations shown in FIGS. 4 and 5 (step S702). In the example of FIGS. 4 and 5, five frames are displayed to have the selected frame as the center.

If the CPU 101 detects pressing of the right scroll button 604 of the infrared remote controller 120 (YES in S703), it sets a timer value used to control the scroll interval to be a standard value, and a scroll direction to be right (S721). After that, the process advances to step S708.

If the CPU 101 does not detect pressing of the right scroll button 604 (NO in S703) but it detects pressing of the left scroll button 605 (YES in S704), the process advances to step S722. In step S722, the CPU 101 sets the timer value used to control the scroll interval to be a standard value, and the scroll direction to be left. The process then advances to step S708.

If the CPU 101 does not detect pressing of the left scroll button 605 (NO in S704) but it detects pressing of the right fast scroll button 603 (YES in S705), the process advances to step S723. In step S723, the CPU 101 sets the timer value used to control the scroll interval to be a fast value, and the scroll direction to be right. The process then advances to step S708.

If the CPU 101 does not detect pressing of the right fast scroll button 603 (NO in S705) but it detects pressing of the left fast scroll button 606 (YES in S706), the process advances to step S724. In step S724, the CPU 101 sets the timer value used to control the scroll interval to be a fast value, and the scroll direction to be left. The process then advances to step S708.

If the CPU 101 does not detect pressing of the left fast scroll button 606 (NO in S706) but it detects pressing of the playback button 601 (YES in S707), the process advances to step S731. If the CPU 101 does not detect pressing of the playback button 601 (NO in S707), the process returns to step S703 to repeat the above processes.

In step S731, the CPU 101 starts cue-playback of a moving image file of the selected frame from the time stamp position based on the moving image frame information 300. The CPU 101 then checks if the stop button 602 is pressed or playback of the moving image has reached the rearmost position (S732). If neither the stop button 602 is pressed nor playback of the moving image has reached the rearmost position (NO in S732), the CPU 101 repeats the checking process in step S732. If at least either the stop button 602 is pressed or playback of the moving image has reached the rearmost position (YES in S732), the CPU 101 ends playback (S733), and the process returns to step S702.

The CPU 101 checks in step S708 if right scrolling is set. If right scrolling is set (YES in S708), the CPU 101 decrements the moving image frame selected position (the frame ID in this case) (S741). On the other hand, if right scrolling is not set (NO in S708), the CPU 101 increments the moving image frame selected position (S709).

The CPU 101 then updates moving image frames displayed on the scroll display area 401 or 501 based on the moving image frame selected position (S710).

The CPU 101 checks if the moving image frame selected position is a predetermined position (S711). Assume that the predetermined position in step S711 is every 20th-frame position in this embodiment. If the moving image frame selected position is not the predetermined position (NO in S711), the CPU 101 pauses based on the timer value (S712) and repeats the processes from step S703. If the CPU 101 determines in step S711 that the moving image frame selected position is the predetermined position (YES in S711), the process advances to step S751.

In step S751, the CPU 101 divides, into a predetermined number of scenes, the range from the start position to the moving image frame selected position. This processing corresponds to grouping processing for grouping frames included in the moving image to a plurality of groups. The CPU 101 selects a rearmost frame of each scene (group) as a representative frame (S752). Subsequently, the CPU 101 divides, into scenes, the range from the moving image frame selected position to the rearmost position (S753), and adds a start frame of each scene as a representative frame (5754).

The CPU 101 lays out and displays images of the selected representative frames in time series on the representative frame display area 403 or 503 in association with the indicator display area 402 or 502 (S755). The process then advances to step S712.

As described above, the image browsing apparatus 100 switches the acquisition method of representative frames based on the characteristic of a user's scroll operation, and displays the acquired representative frame on the display 110. For this reason, the user can display representative frames by various methods by appropriately executing a simple scroll operation. Therefore, an image browsing technique with high operability is provided.

The image browsing apparatus 100 switches the acquisition method of representative frames based on the position of the selected frame in all images (image array). For this reason, the user can display representative frames by various methods by appropriately selecting a frame by a scroll operation.

The image browsing apparatus 100 acquires a predetermined number of representative frames at equal intervals from at least one of the ranges before and after the selected frame. For this reason, the user can recognize the contents of the whole moving image data by a simple operation.

The image browsing apparatus 100 divides images included in all images into a plurality of groups, and acquires representative images from these groups as representative frames. In this way, since the representative frame is a frame that represents each group, the user can easily recognize the contents of the whole moving image data with reference to the representative frames.

The image browsing apparatus 100 displays the positions of the selected frame and representative frames in all the frames on the display 110. Hence, the user can recognize a change in overall image at a glance.

The image browsing apparatus 100 controls to play back a moving image from the selected frame in response to a user's instruction. Hence, the user can confirm the contents by playing back the moving image from a desired frame.

According to this embodiment, every time 20 frames are scrolled, the selection range of representative frames in the scroll direction is narrowed down to be divided into more detailed scenes, thus allowing the user to easily recognize the position of a target scene from the representative frame.

Note that this embodiment has exemplified the case in which moving image frames in moving image data as video data are to be browsed. However, even upon browsing a plurality of still image data, if they are sorted in a significant order of, for example, photographing dates and times or the like, the same effects can be obtained.

This embodiment has exemplified the case in which moving image frames are scroll-displayed. However, the same effects can be obtained even for general playback display.

This embodiment has exemplified the case in which the range from the start position to the moving image frame selected position or from the moving image frame selected position to the rearmost position is selected. However, when the selection range may be increased/decreased by a size sufficiently smaller than the selection range, the same effects can be obtained.

The moving image may be encoded by a compression method such as MPEG encoding using difference information between frames. In this case as well, the same processing as described above can be applied to respective decoded frames.

### Second Embodiment

The second embodiment of the present invention will be described in detail hereinafter with reference to the drawings. This embodiment will explain an arrangement that acquires representative frames from frames which exist in the scroll direction.

Note that the hardware arrangement is the same as that in the first embodiment described using FIG. 1. The functional arrangement is the same as that in the first embodiment described using FIG. 2. Also, moving image frame information is the same as that in the first embodiment described using FIG. 3. An infrared remote controller is the same as that in the first embodiment described using FIG. 6.

(User Interface Screen)

FIGS. 8 and 9 show examples of user interface screens upon left scrolling in this embodiment. As in FIGS. 4 and 5, user interface screens 800 and 900 respectively include scroll display areas 801 and 901, indicator display areas 802 and 902, and representative frame image display areas 803 and 903. The representative frame image display areas 803 and 903 display only representative frame images in only the direction of scrolling unlike the representative frame image display areas 403 and 503.

More specifically, since the user makes left scrolling, that is, scrolling toward the end of moving image data, representative frames are selected from a range from a frame selected position “01.20.0” to a rearmost time position “12.46.5”, in FIG. 8. In FIG. 9, since the user interface screen 900 is scrolled more than the screen 800, representative frames are selected from a narrower range, that is, a range from a time position “07.40.0” to the rearmost position.

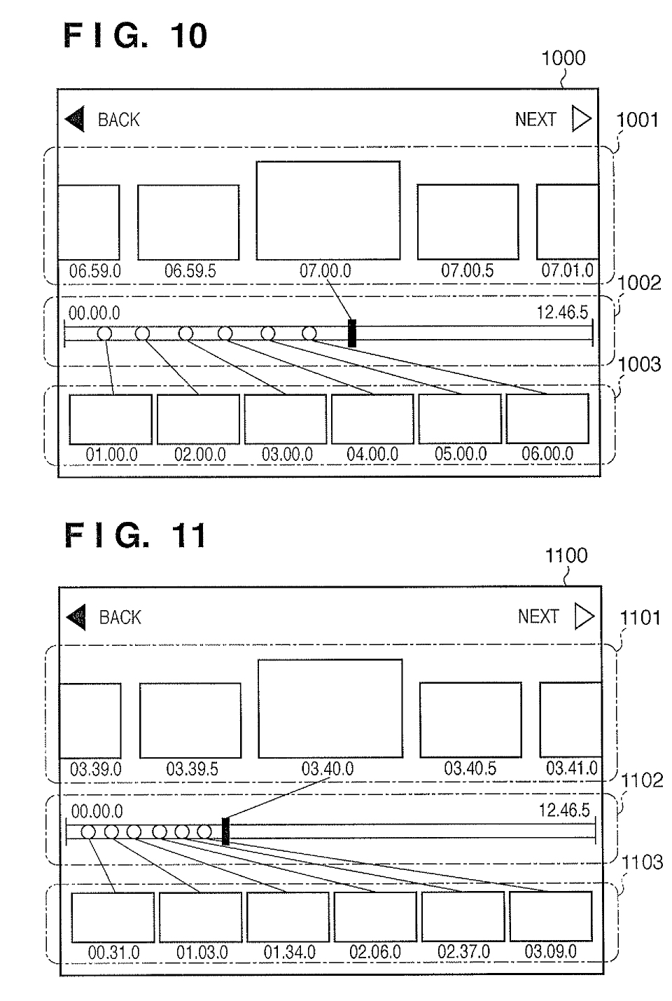

FIGS. 10 and 11 show examples of user interface screens upon right scrolling in this embodiment. As in FIGS. 8 and 9, user interface screens 1000 and 1100 respectively include scroll display areas 1001 and 1101, indicator display areas 1002 and 1102, and representative frame image display areas 1003 and 1103. The representative frame image display areas 1003 and 1103 display only representative frame images in only the direction of scrolling as in the representative frame image display areas 803 and 903.

In FIG. 10, since the scroll display direction is opposite to the playback direction, the representative frame image display area 1003 displays representative frame images in a range opposite to those in the representative frame image display areas 803 and 903. In FIG. 11, since the user interface screen 1100 is scrolled more than the screen 1000, representative frames are selected from a narrower range.

Note that the user interface screens 800, 900, 1000, and 1100 are examples, and the configuration, layout, and the like are not limited to those shown in FIGS. 8 to 11.

(Main Processing)

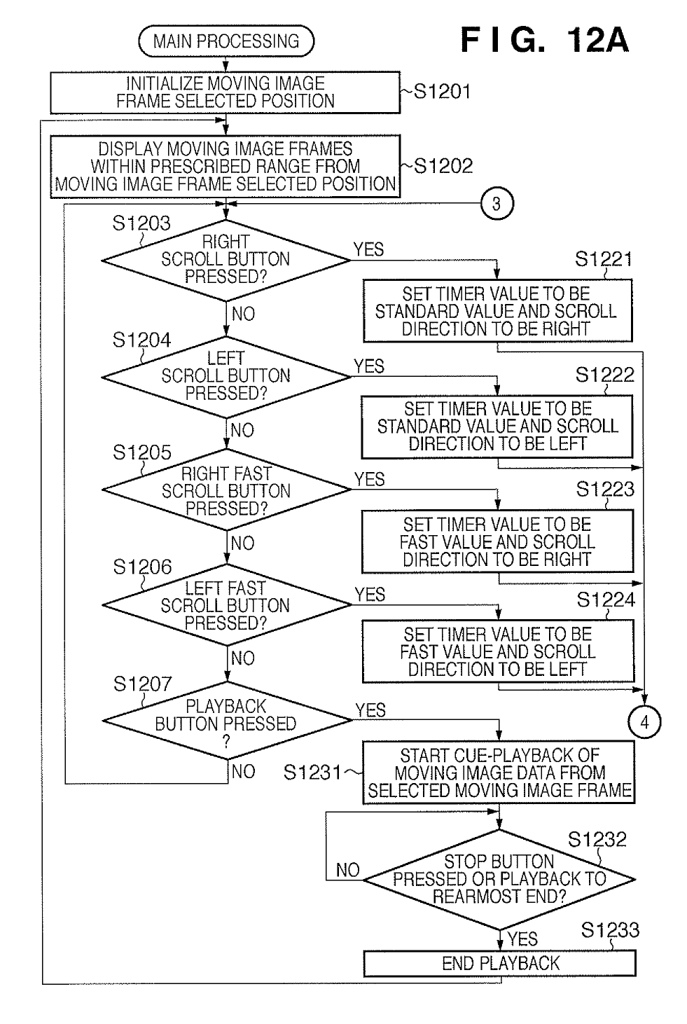

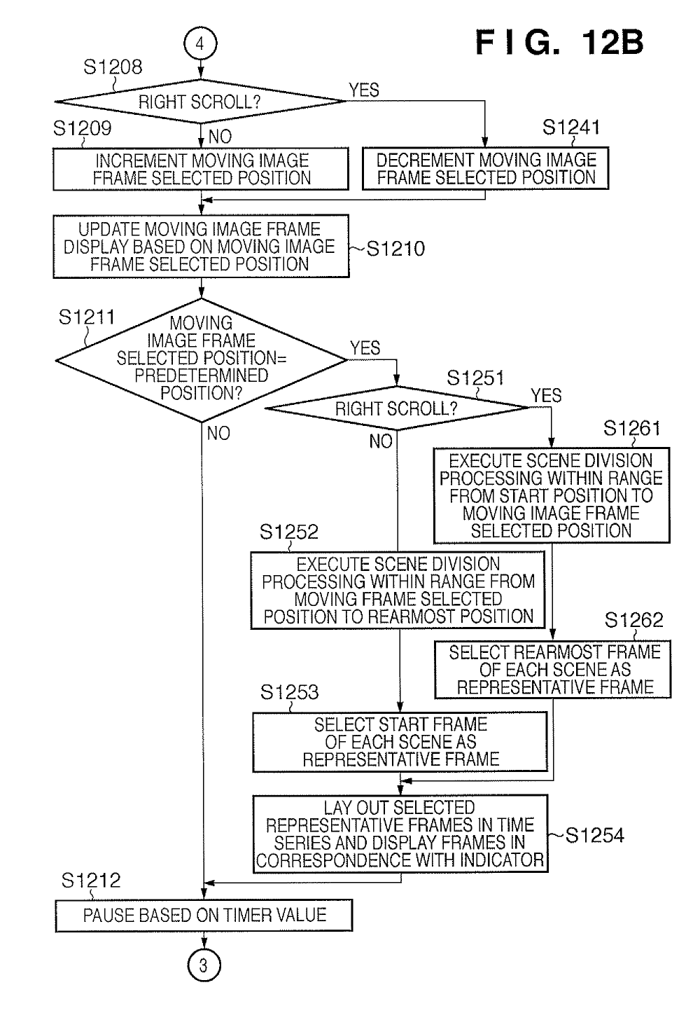

FIGS. 12A and 12B are flowcharts showing the sequence of main processing of an image browsing apparatus 100 according to this embodiment. Respective steps of the sequence shown in FIGS. 12A and 12B are executed under the control of a CPU 101.

When the main processing starts, as shown in FIG. 12A, the CPU 101 initializes the moving image frame selected position (S1201). In this case, the CPU 101 sets the frame ID to be zero.

The CPU 101 displays frame images of frames within a predetermined range from the moving image frame selected position in accordance with the screen configurations shown in FIGS. 8 to 11 (step S1202).

If the CPU 101 detects pressing of a right scroll button 604 of an infrared remote controller 120 (YES in S1203), the process advances to step S1221. In step S1221, the CPU 101 sets a timer value used to control the scroll interval to be a standard value, and a scroll direction to be right. After that, the process advances to step S1208.

If the CPU 101 does not detect pressing of the right scroll button 604 (NO in S1203) but it detects pressing of a left scroll button 605 (YES in S1204), the process advances to step S1222. In step S1222, the CPU 101 sets the timer value used to control the scroll interval to be a standard value, and the scroll direction to be left. The process then advances to step S1208.

If the CPU 101 does not detect pressing of the left scroll button 605 (NO in S1204) but it detects pressing of a right fast scroll button 603 (YES in S1205), the process advances to step S1223. In step S1223, the CPU 101 sets the timer value used to control the scroll interval to be a fast value, and the scroll direction to be right. The process then advances to step S1208.

If the CPU 101 does not detect pressing of the right fast scroll button 603 (NO in S1205) but it detects pressing of a left fast scroll button 606 (YES in S1206), the process advances to step S1224. In step S1224, the CPU 101 sets the timer value used to control the scroll interval to be a fast value, and the scroll direction to be left. The process then advances to step S1208.

If the CPU 101 does not detect pressing of the left fast scroll button 606 (NO in S1206) but it detects pressing of a playback button 601 (YES in S1207), the process advances to step S1231. In step S1231, the CPU 101 starts cue-playback of a moving image file of the selected frame from the time stamp position based on moving image frame information 300.

The CPU 101 then checks if a stop button 602 is pressed or playback of the moving image has reached the rearmost position (S1232). If neither the stop button 602 is pressed nor playback of the moving image has reached the rearmost position (NO in S1232), the CPU 101 repeats the checking process in step S1232. If at least either the stop button 602 is pressed or playback of the moving image has reached the rearmost position (YES in S1232), the CPU 101 ends playback (S1233), and the process returns to step S1202.

If the CPU 101 does not detect pressing of the playback button 601 (NO in S1207), it repeats the above processes from step S1203.

The CPU 101 checks in step S1208 if right scrolling is set. If right scrolling is set (YES in S1208), the CPU 101 decrements the moving image frame selected position (the frame ID in this case) (S1241). On the other hand, if right scrolling is not set (NO in S1208), the CPU 101 increments the moving image frame selected position (S1209).

The CPU 101 then updates moving image frames displayed on the scroll display area based on the moving image frame selected position (S1210).

The CPU 101 checks if the moving image frame selected position is a predetermined position (S1211). Assume that the predetermined position in step S1211 is every 20th-frame position in this embodiment. If the moving image frame selected position is not the predetermined position (NO in S1211), the CPU 101 pauses based on the timer value (S1212) and repeats the processes from step S1203. If the CPU 101 determines in step S1211 that the moving image frame selected position is the predetermined position (YES in S1211), the process advances to step S1251.

The CPU 101 checks in step S1251 if right scrolling is set. If the CPU 101 determines right scrolling in step S1251 (YES in S1251), it divides, into scenes, a range from the start position to the moving image frame selected position (S1261), and selects rearmost frames of respective scenes as representative frames (S1262). The process then advances to step S1254.

If the CPU 101 determines in step S1251 that right scrolling is not set (NO in S1251), it divides, into scenes, a range from the moving image frame selected position to the rearmost position (S1252), and selects rearmost frames of respective scenes as representative frames (S1253). The process then advances to step S1254.

The CPU 101 lays out and displays images of the selected representative frames in time series on the representative frame display area in association with the indicator display area (S1254). The process then advances to step S1212.

As described above, in this embodiment, representative frames are selected from frames which exist in the scroll direction. Then, only representative frames in a direction to be successively displayed are displayed. For this reason, scenes are divided finely, and the selection range of the scenes is narrowed down to display more detailed scenes, thus allowing the user to easily recognize the position of a target scene from the representative frames.

Note that this embodiment has exemplified the case in which moving image frames in moving image data as video data are to be browsed. However, even upon browsing a plurality of still image data, if they are sorted in a significant order of, e.g., photographing dates or the like, the same effects can be obtained.

This embodiment has exemplified the case in which moving image frames are scroll-displayed. However, the same effects can be obtained even for general playback display.

This embodiment has exemplified the case in which the range from the start position to the moving image frame selected position or from the moving image frame selected position to the rearmost position is selected. However, when the selection range may be increased/decreased by a size sufficiently smaller than the selection range, the same effects can be obtained.

### Third Embodiment

The third embodiment of the present invention will be described in detail hereinafter with reference to the drawings. This embodiment will explain an arrangement that switches the acquisition method of representative frames based on a scroll speed.

Note that the hardware arrangement is the same as that in the first embodiment described using FIG. 1. Also, moving image frame information is the same as that in the first embodiment described using FIG. 3. An infrared remote controller is the same as that in the first embodiment described using FIG. 6. Note that the same reference numerals denote the same components throughout the drawings unless otherwise specified, and a description thereof will not be repeated.

(Functional Arrangement)

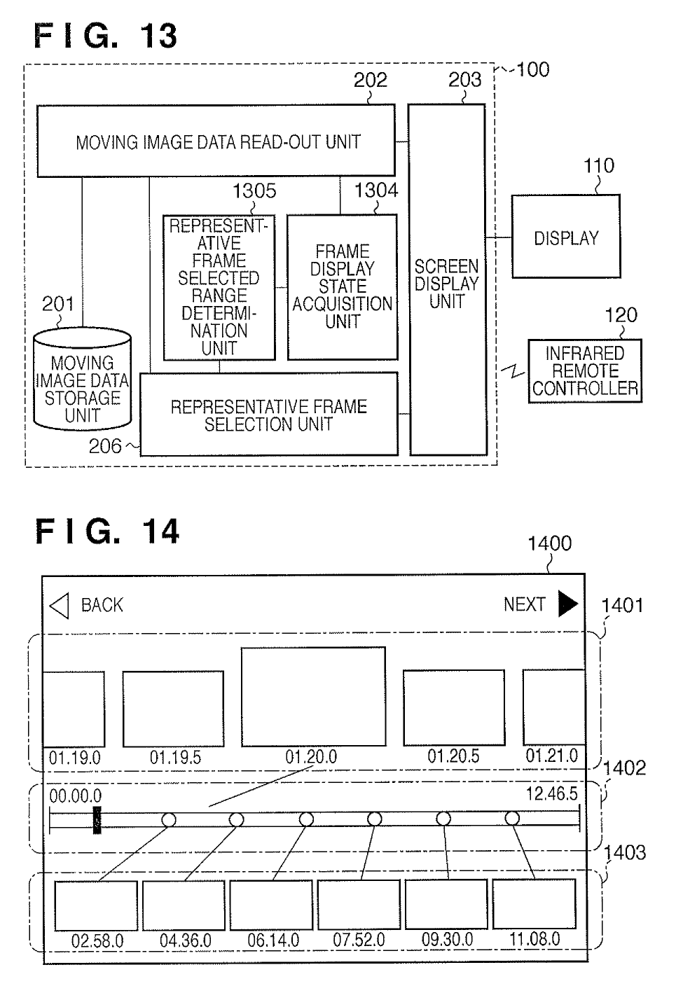

FIG. 13 is a block diagram showing the functional arrangement of an image browsing apparatus 100 according to this embodiment. As shown in FIG. 13, the image browsing apparatus 100 comprises a moving data storage unit 201, moving image data read-out unit 202, screen display unit 203, frame display state acquisition unit 1304, representative frame selection range determination unit 1305, and representative frame selection unit 206.

The frame display state acquisition unit 1304 acquires a display rate of frames which are read out by the moving image data read-out unit 202 and are sequentially displayed by the screen display unit 203, i.e., a value that can be used to calculate the number of displayed frames per unit time. In this embodiment, the frame display state acquisition unit 1304 acquires a timer value used to specify the display interval of frames. The frame display state acquisition unit 1304 acquires a frame selected position of frames, which are read out by the moving image data read-out unit 202 and are sequentially displayed by the screen display unit 203.

The representative frame selection range determination unit 1305 determines a selection range of representative frames in accordance with the display rate and frame selected position acquired via the frame display state acquisition unit 1304.

In this embodiment, when the scroll speed is high, a range from the start position to the frame selected position or from the frame selected position to the rearmost position of a moving image is determined as the representative frame selection range. When the scroll speed is a standard speed, a range half of that from the frame selected position to the start position or from the frame selected position to the rearmost position of a moving image is determined as the representative frame selection range.

In this embodiment, upon pressing a fast scroll button 603 or 606, fast scrolling is set. Upon pressing a normal scroll button 604 or 605, scrolling at a normal speed is set. However, the present invention is not limited to this. For example, when scrolling is made using a pointing device, jog dial, or the like, if the scroll speed is equal to or higher than a predetermined threshold, a high speed is set; if it is less than the threshold, a normal speed is set. In this embodiment, such modification corresponds to a case in which a speed between the scroll speed upon pressing of the fast scroll button 603 or 606 and that upon pressing of the normal scroll button 604 or 605 is used as a threshold.

(User Interface Screen)

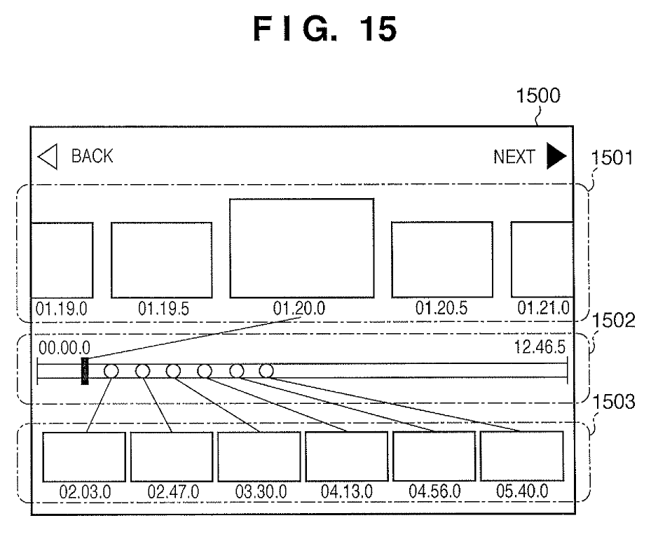

FIGS. 14 and 15 show examples of user interface screens upon left scrolling in this embodiment. As in FIGS. 4 and 5, user interface screens 1400 and 1500 respectively include scroll display areas 1401 and 1501, indicator display areas 1402 and 1502, and representative frame image display areas 1403 and 1503.

The representative frame image display areas 1403 and 1503 display only representative frame images in only the direction of scrolling unlike the representative frame image display areas 403 and 503 (FIGS. 4 and 5). More specifically, since scrolling is made toward the end of moving image data, representative frames are selected from a range after a frame selected position “01.20.0”. In the example of the user interface screen 1500, the scroll speed is lower than that on the screen 1400. For this reason, representative frames are selected from a narrower range than the user interface screen 1400, i.e., a range between time positions “02.03.0” and “05.40.0”.

(Main Processing)

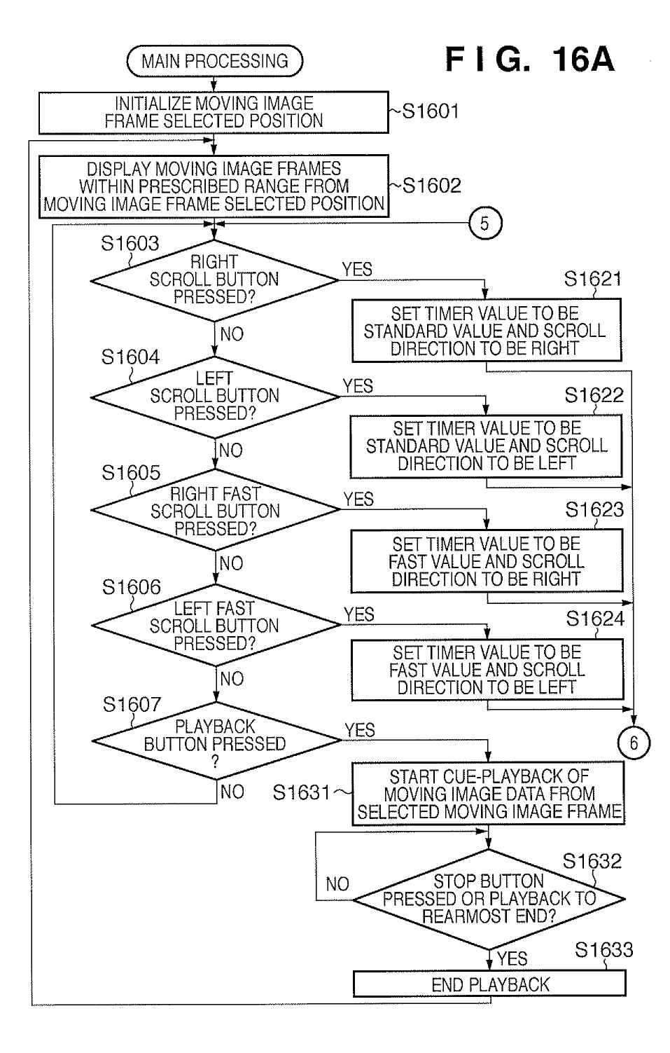

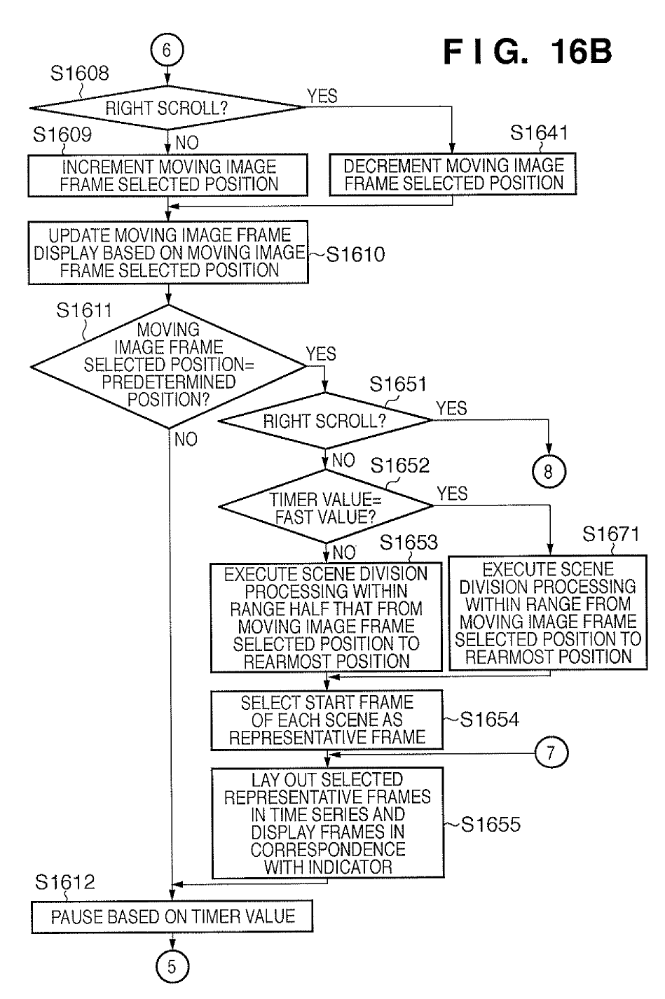

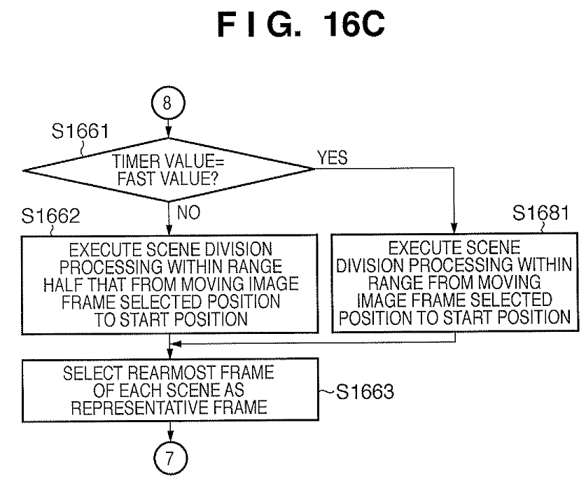

FIGS. 16A, 16B, and 16C are flowcharts showing the sequence of main processing of the image browsing apparatus according to this embodiment. Respective steps of the sequence shown in FIGS. 16A, 16B, and 16C are executed under the control of a CPU 101.

When the main processing starts, as shown in FIG. 16A, the CPU 101 initializes the moving image frame selected position (S1601). In this case, the CPU 101 sets the frame ID to be zero (S1601).

The CPU 101 displays frame images of frames which belong to a predetermined range from the moving image frame selected position in accordance with the screen configurations shown in FIGS. 14 and 15 (step S1602).

If the CPU 101 detects pressing of the right scroll button 604 of an infrared remote controller 120 (YES in S1603), the process advances to step S1621. In step S1621, the CPU 101 sets a timer value used to control the scroll interval to be a standard value, and a scroll direction to be right. After that, the process advances to step S1608.

If the CPU 101 does not detect pressing of the right scroll button 604 (NO in S1603) but it detects pressing of the left scroll button 605 (YES in S1604), the process advances to step S1622. In step S1622, the CPU 101 sets the timer value used to control the scroll interval to be a standard value, and the scroll direction to be left. The process then advances to step S1608.

If the CPU 101 does not detect pressing of the left scroll button 605 (NO in S1604) but it detects pressing of the right fast scroll button 603 (YES in S1605), the process advances to step S1623. In step S1623, the CPU 101 sets the timer value used to control the scroll interval to be a fast value, and the scroll direction to be right. The process then advances to step S1608.

If the CPU 101 does not detect pressing of the right fast scroll button 603 (NO in S1605) but it detects pressing of the left fast scroll button 606 (YES in S1606), the process advances to step S1624. In step S1624, the CPU 101 sets the timer value used to control the scroll interval to be a fast value, and the scroll direction to be left. The process then advances to step S1608.

If the CPU 101 does not detect pressing of the left fast scroll button 606 (NO in S1606) but it detects pressing of a playback button 601 (YES in S1607), the process advances to step S1631. If the CPU 101 does not detect pressing of the playback button 601 (NO in S1607), it repeats the processes from step S1603.

In step S1631, the CPU 101 starts cue-playback of a moving image file of the selected frame from the time stamp position based on moving image frame information 300. The CPU 101 then checks in step S1632 if a stop button 602 is pressed or playback of the moving image has reached the rearmost position. If neither the stop button 602 is pressed nor playback of the moving image has reached the rearmost position (NO in S1632), the CPU 101 repeats the checking process in step S1632. If at least either the stop button 602 is pressed or playback of the moving image has reached the rearmost position (YES in S1632), the CPU 101 ends playback (S1633), and the process returns to step S1602.

The CPU 101 checks in step S1608 if right scrolling is set. If right scrolling is set (YES in S1608), the CPU 101 decrements the moving image frame selected position (the frame ID in this case) (S1641). On the other hand, if right scrolling is not set (NO in S1608), the CPU 101 increments the moving image frame selected position (S1609).

The CPU 101 then updates moving image frames displayed on the scroll display area based on the moving image frame selected position (S1610).

If the moving image frame selected position is not a predetermined position (NO in S1611), the CPU 101 pauses based on the timer value (S1612) and repeats the processes from step S1603. Assume that the predetermined position in step S1611 is every 20th-frame position in this embodiment.

If the CPU 101 determines in step S1611 that the moving image frame selected position is the predetermined position (YES in S1611), the process advances to step S1651.

The CPU 101 checks in step S1651 if a user's operation instructs right scrolling (including fast scrolling). If the CPU 101 determines that the user's operation instructs right scrolling (YES in S1651), the process advances to step S1661; otherwise (i.e., left scrolling) (NO in S1651), the process advances to step S1652.

The CPU 101 checks in step S1652 if the timer value is a fast value. That is, the CPU 101 checks if the scroll speed of left scrolling is equal to or higher than a predetermined threshold.

If the CPU 101 determines in step S1652 that the timer value is not a fast value (the scroll speed is less than the threshold) (NO in S1652), it divides, into scenes, a range half of that from the moving image frame selected position to the rearmost position (S1653). The process then advances to step S1654.

On the other hand, if the CPU 101 determines in step S1652 that the timer value is a fast value (the scroll speed is equal to or higher than the threshold) (YES in S1652), it divides, into scenes, a range from the moving image frame selected position to the rearmost position (S1671), and the process advances to step S1654.

In step S1654, the CPU 101 selects start frames of respective scenes as representative frames. The process then advances to step S1655.

In step S1655, the CPU 101 lays out and displays the selected representative frames in time series on the display 110 in association with the indicator. The process then returns to step S1612.

On the other hand, the CPU 101 checks in step S1661 if the timer value is a fast value (S1661). That is, the CPU 101 checks if the scroll speed of right scrolling is equal to or higher than the predetermined threshold.

If the CPU 101 determines in step S1661 that the timer value is not a fast value (NO in S1661), it divides, into scenes, a range half of that from the moving image frame selected position to the start position (S1662). The CPU 101 selects rearmost frames of respective scenes as representative frames (S1663), and the process then advances to step S1655.

On the other hand, if the CPU 101 determines in step S1661 that the timer value is a fast value (YES in S1661), it divides, into scenes, a range from the moving image frame selected position to the start position (S1681), and the process advances to step S1663.

The CPU 101 lays out and displays images of the selected representative frames in time series on the representative frame display area in association with the indicator display area (S1655). The process then advances to step S1612.

As described above, in this embodiment, only representative frames in a direction to be successively displayed are displayed in accordance with the scroll direction. For this reason, scenes are divided finely, and the selection range of the scenes is narrowed down to display more detailed scenes, thus allowing the user to easily recognize the position of a target scene from the representative frames.

Furthermore, in this embodiment, when the scroll speed is less than the predetermined threshold, representative images are acquired from a group that neighbors the selected frame. That is, when the scroll speed is low, representative frames within a narrow range are displayed. When the scroll speed is high, representative frames within a broad range are displayed. For this reason, scenes are divided in detail in correspondence with the stoppable level of scrolling, and the recognizability of the position of a target scene can be improved.

Note that this embodiment has exemplified the case in which moving image frames in moving image data as video data are to be browsed. However, even upon browsing a plurality of still image data, if they are sorted in a significant order of, e.g., photographing dates and times or the like, the same effects can be obtained.

This embodiment has exemplified the case in which moving image frames are scroll-displayed. However, the same effects can be obtained even for general playback display. Also, the same effects can be obtained by increasing/decreasing the selection range of this embodiment within a predetermined range.

As described above, in the arrangement of this embodiment, as the position of a displayed content progresses, the selection range of representative images (representative frames) is narrowed down. For this reason, the user can easily recognize the position of a desired content from the representative images. Since the user's operation is only a scroll operation, the operability is very high.

Therefore, according to the present invention, an image browsing technique with high operability can be provided.

### Fourth Embodiment

(System Arrangement)

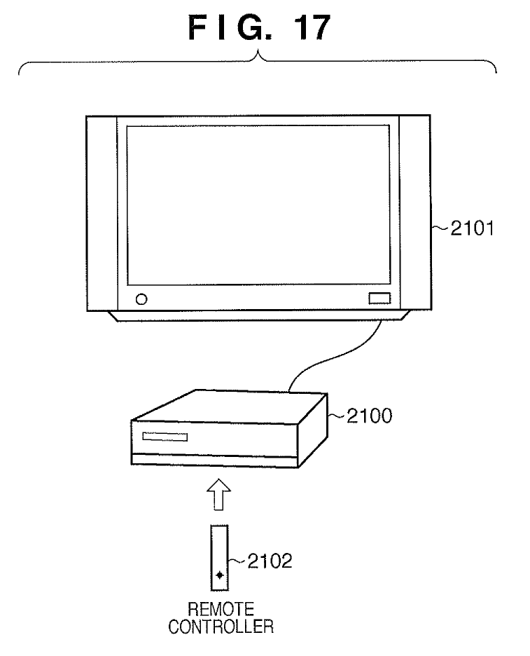

FIG. 17 shows a basic system arrangement of a moving image display apparatus (display control apparatus) 2100 according to the fourth embodiment of the present invention. As shown in FIG. 17, a display 2101 which can display moving image data is connected to the moving image display apparatus 2100. Various operation instructions from the user are made using an operation input device 2102 represented by a remote controller.

In this embodiment, the moving image display apparatus 2100 is implemented by a set-top box. However, the moving image display apparatus 2100 may be implemented by other digital home electric appliances such as a home game machine, digital video disk (DVD) player, DVD recorder, digital camera, digital video camera, flat-screen TV, and the like. Alternatively, the moving image display apparatus 2100 may be implemented by information processing apparatuses such as a personal computer (PC), workstation, portable information terminal (PDA), and the like, a mobile phone, and electronic parts such as a semiconductor integrated circuit and the like.

The operation input device 2102 may be implemented by a keyboard, pointing device, touch panel, or the like.

(Hardware Arrangement)

FIG. 18 is a block diagram showing the hardware arrangement of the moving image display apparatus 2100 according to this embodiment. As shown in FIG. 18, the moving image display apparatus 2100 comprises, as hardware components, a CPU 2201, RAM 2202, ROM 2203, and display interface (display I/F) 2204. Also, the moving image display apparatus 2100 comprises a storage interface (storage I/F) 2205, storage 2206, and remote controller interface (remote controller I/F) 2207.

The CPU 2201 executes application programs, an operating system (OS), control programs, and the like, which are stored in the storage 2206. The CPU 2201 controls the RAM 2202 to temporarily store information, files, and the like required to execute the programs.

The ROM 2203 is a read only memory, and stores programs such as a basic I/O program and the like, and various data such as font data, template data, and the like used in basic processing. The RAM 2202 is a random access memory. The RAM 2202 temporarily stores various data, and serves as a main memory, work area, and the like of the CPU 2201.

The display interface 2204 converts screen information generated inside the moving image display apparatus 2100 into a signal that the display 2101 can process. The storage interface 2205 converts a data format that can be used inside the moving image display apparatus 2100 and that required to store data in the storage. The remote controller interface 2207 receives a signal from the operation input device 2102, and converts the received signal into information that the moving image display apparatus 2100 can process.

Although not shown in FIG. 18, processing programs according to the present invention, device drivers, and the like as well as an OS are stored in the ROM 2203, are temporarily stored in the RAM 2202 as needed, and are executed by the CPU 2201. Note that the OS may be stored in the storage 2206. In this case, the OS is loaded onto the RAM 2202 upon power ON, and is booted up by the CPU 2201. The storage 2206 records a huge volume of data to be retrieved and played back by the moving image display apparatus 2100. The storage 2206 may be incorporated in the moving image display apparatus 2100 or may be connected to the moving image display apparatus 2100 via various interfaces such as Ethernet®, USB, and the like. A plurality of storages 2206 may be connected via interfaces.

Note that the same reference numerals denote the same components throughout the drawings unless otherwise specified, and a detailed description thereof will not be repeated.

(Functional Arrangement)

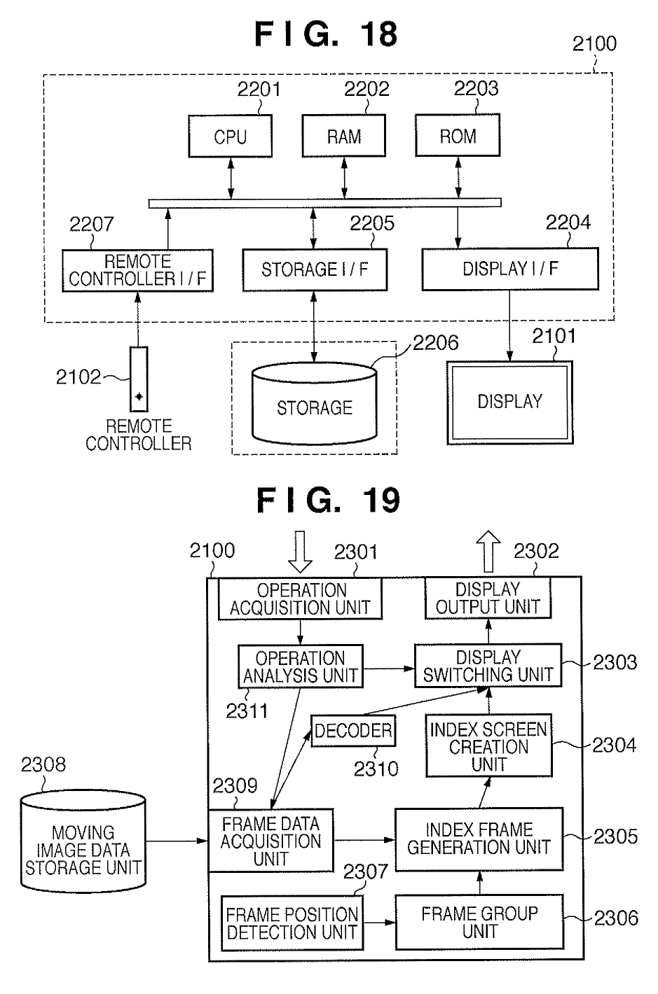

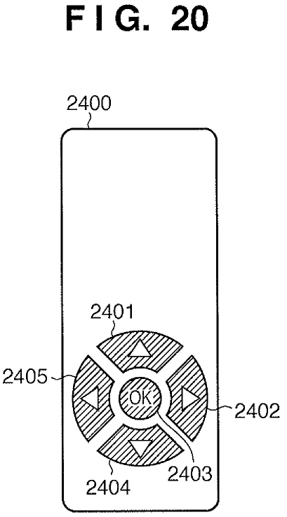

FIG. 19 is a functional block diagram of the moving image display apparatus 2100 according to this embodiment. As shown in FIG. 19, the moving image display apparatus 2100 comprises an operation acquisition unit 2301, display output unit 2302, display switching unit 2303, index screen creation unit 2304, index frame generation unit 2305, frame grouping unit 2306, and frame position detection unit 2307. Furthermore, the apparatus 2100 comprises a moving image data storage unit 2308, frame data acquisition unit 2309, decoder 2310, and operation analysis unit 2311. These functional blocks can be implemented in various forms by combinations of hardware and software.

The moving image data storage unit 2308 stores a huge volume of moving image data to be retrieved and played back by the moving image display apparatus 2100. In this embodiment, each moving image stored in the moving image data storage unit 2308 is moving image data including a plurality of frames. However, the moving image stored in the moving image data storage unit 2308 is not limited to that including a plurality of moving image frames, and moving image data in any other formats may be stored as long as they can be converted into a frame format that can be used in this embodiment. For example, MPEG-2 data has I-, P-, and B-frames. In this embodiment, P- and B-frames which have undergone inter-frame compression based on differences from other frames are not stored, and only I-frames that have undergone only spatial compression can be stored. On the other hand, all frames of MotionJPEG data may be stored in the moving image data storage unit 2308.

The frame data acquisition unit 2309 sequentially reads out data of frames from the moving image data storage unit 2308. The frame position detection unit 2307 detects the position of each readout frame in moving image data. The detected frame position information is held in the RAM 2202 of the moving image display apparatus 2100, and is used by the frame grouping unit 2306.

The frame grouping unit 2306 groups frames at different frame intervals proportional to the distances from the detected frame positions. The index frame generation unit 2305 extracts a representative frame from each of the groups grouped by the frame grouping unit 2306 to generate an index frame.

The index screen creation unit 2304 creates a screen on which a plurality of index frames generated by the index frame generation unit 2305 are laid out in the frame order. The created index screen is output from the display output unit 2302 to the display 2101 such as a digital TV or the like via the display switching unit 2303.

The operation acquisition unit 2301 acquires the operation contents from the user from the remote controller interface 2207. The operation analysis unit 2311 analyzes the operation contents acquired by the operation acquisition unit 2301. The display switching unit 2303 switches the display contents of the index screen that the user wants, based on the analysis result of the operation analysis unit 2311. The frame data acquisition unit 2309 acquires a moving image that the user wants based on the analysis result of the operation analysis unit 2311. The decoder 2310 decodes frames acquired by the frame data acquisition unit 2309 to acquire images.

(Operation Input Device)

The user confirms the screen output to the display 2101, and makes various operations to the moving image display apparatus 2100 using the operation input device 2102. FIG. 20 shows an example of the operation input device 2102 used to operate the moving image display apparatus 2100.

In this embodiment, the operation input device corresponds to a remote controller 2400. The remote controller 2400 comprises left and right buttons 2402 and 2405 used to change a focused frame, and an OK button 2403 used to settle selection of the focused frame. In this embodiment, when the user makes the selection settlement operation of the frame using the OK button 2403, moving image data can be played back from the selected frame position. The remote controller 2400 also comprises up and down buttons 2401 and 2404, which are not used in this embodiment.

Various operations instructed by the user using the remote controller 2400 are fetched by the moving image display apparatus 2100 via the operation acquisition unit 2301, and the results analyzed by the operation analysis unit are fed back to the display switching unit 2303 and frame data acquisition unit 2309.

(Surveying Index Display Processing)

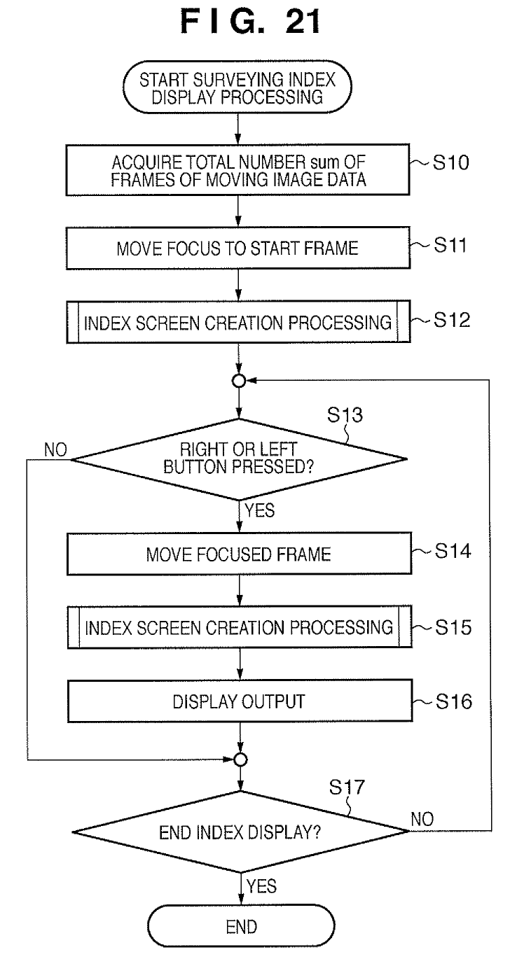

FIG. 21 is a flowchart showing the main sequence of surveying index display processing executed by the moving image display apparatus 2100 in this embodiment. Details of the surveying index display processing in this embodiment will be described below with reference to this flowchart. Processes in respective steps are executed under the control of the CPU 2201.

As shown in FIG. 21, when the surveying index display processing is started in the moving image display apparatus 2100, the moving image display apparatus 2100 acquires the total number of frames of moving image data which is to undergo index display processing (step S10). The apparatus 2100 holds the acquired value in a variable sum.

The moving image display apparatus 2100 focuses the first frame of the moving image data which is to undergo the index display processing (step S11).

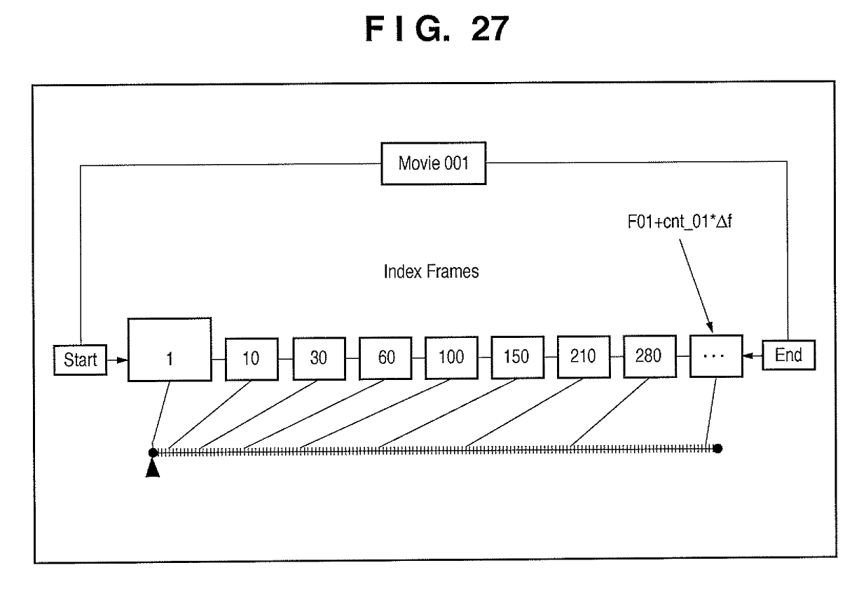

The moving image display apparatus 2100 creates an index display screen to be initially displayed based on that first frame (step S12). The initial index display screen created at that time will be described below with reference to FIG. 27. FIG. 27 shows an example of the initial index display screen.

As shown in FIG. 27, a focused frame (first frame) and index frames (second frames) are sorted and displayed on the frame order. In this embodiment, the focused frame is distinguished from the index frames by displaying this frame to have a size larger than the index frames. Alternatively, the focused frame may be distinguished from the index frames using a different color, shape, or the like when it is displayed. Details of the processing for displaying the index screen will be described later.

The user inputs an instruction to the moving image display apparatus 2100 using the initial index display screen displayed on the display 2101 and the remote controller 2400. Upon pressing the left or right key 2402 or 2405 of the remote controller 2400 (YES in step S13), the moving image display apparatus 2100 moves the focused frame to the left or right (step S14).

The moving image display apparatus 2100 creates an index display screen again based on the newly focused frame (step S15). Details of the processing for displaying the index screen will be described later.

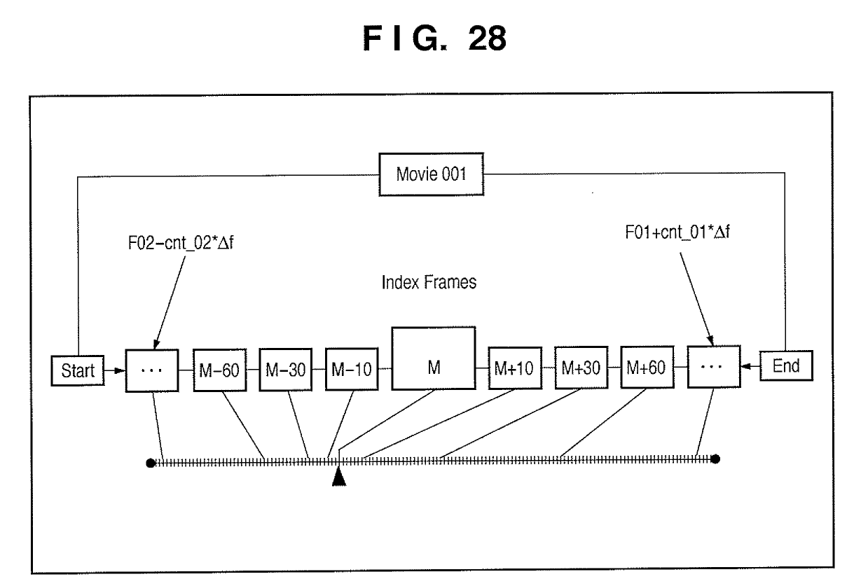

The moving image display apparatus 2100 updates and displays the screen on the display 2101 (step S16). The index display screen created at that time will be described below with reference to FIG. 28. FIG. 28 shows an example of the index display screen.

As shown in FIG. 28, the moving image display apparatus 2100 displays index frames near the focused frame at fine (small) frame intervals and those farther away from the focused frame at coarse (large) frame intervals. The user selects a frame displayed in this way by pressing the OK button 2403 of the remote controller 2400, thus playing back the moving image from the selected frame.

Upon detection of an index display end instruction (YES in step S17), the moving image display apparatus 2100 ends the main sequence of the surveying index display processing shown in FIG. 21.

(Index Screen Creation Processing)

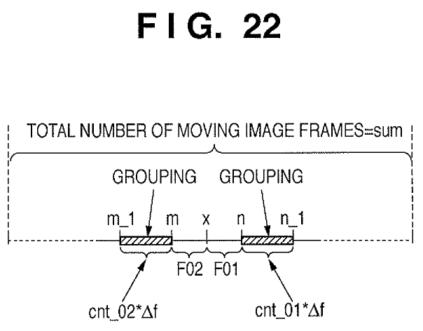

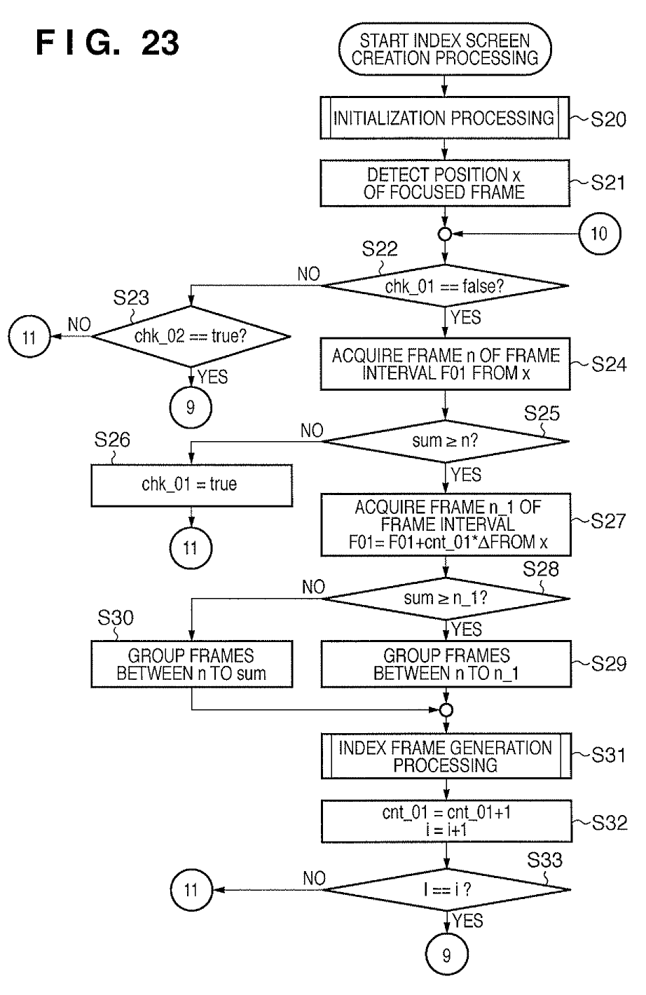

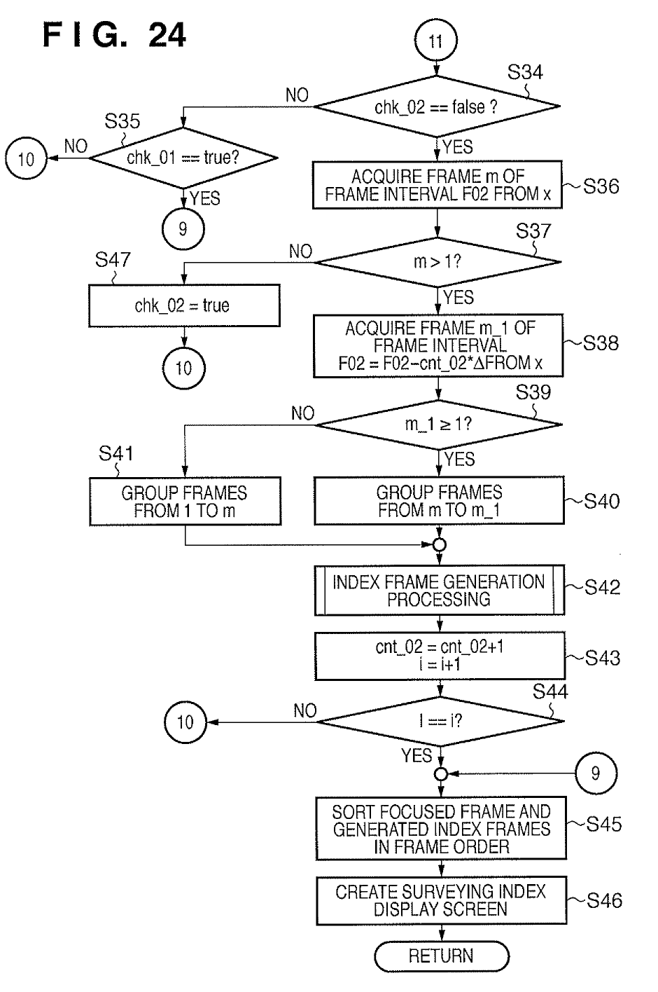

The index screen creation processing executed in steps S12 and S15 of the flowchart shown in FIG. 21 will be described below with reference to FIGS. 22 to 24. FIG. 22 is a view for explaining the index screen creation algorithm of this embodiment, and FIGS. 23 and 24 are flowcharts showing the sequence of the index screen creation processing.

As shown in FIG. 22, in the index screen creation processing, processing for grouping frames at equal distances, i.e., equal frame intervals before and after a position x of the focused frame, and extracting index frames as representative frames from these groups is executed. The sequence of the index screen creation processing will be described below with reference to FIGS. 23 and 24.

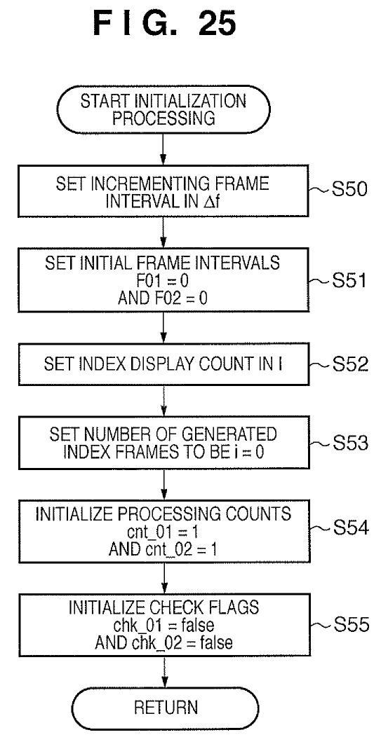

Upon starting the index screen creation processing, as shown in FIG. 23, the CPU 2201 executes initialization processing first (step S20). FIG. 25 is a flowchart showing the processing sequence of the initialization processing.

In the initialization processing, the CPU 2201 sets an incremental frame interval (step S50). The index frames generated by the moving image display apparatus 2100 are representative frames of groups, which are grouped at different frame intervals. By appropriately setting this incremental frame interval, grouping at various frame intervals can be attained. In this embodiment, the CPU 2201 sets the incremental frame interval in Δf to broaden the frame interval in proportion to the distance from the position of the focused frame, as described above. However, the present invention is not limited to this. For example, the incremental frame interval may be decreased according to the position of the focused frame or may be increased like a quadratic curve.

The CPU 2201 sets initial frame intervals F01=0 and F02=0 (step S51) and sets an index display count in I (step S52). The index display count I is a constant indicating the number of index frames displayed on the screen. For example, when six index frames are to be displayed on the index display screen, I=6 is set.

The CPU 2201 resets a variable i used to hold the number of index frames created by the index screen creation processing to zero (step S53). The CPU 2201 then initializes processing counts cnt_01=1 and cnt_02=1 (step S54), and initializes check flags chk_01=false and chk_02=false (step S55).

Note that the check flag chk_01 is a flag indicating whether or not frame acquisition after the focused frame is complete, in other words, whether or not frames after the focused frame can be further acquired. chk_01=false indicating that frame acquisition is not complete yet, i.e., frames can be further acquired, and chk_01=true indicates that frame acquisition is complete. Likewise, the check flag chk_02 is a flag indicating whether or not frame acquisition before the focused frame is complete, in other words, whether or not frames before the focused frame can be further acquired. In this way, the sequence of the initialization processing is complete, and the control returns to the sequence of the index screen creation processing.

A description will revert to FIG. 23. Upon completion of the initialization processing (step S20), the CPU 2201 detects the position of the focused frame in the moving image data, and holds it in a variable x (step S21).

The CPU 2201 checks if chk_01==false, i.e., if chk_01 is false (step S22). If chk_01=true (NO in step S22), the process advances to step S23; if chk_01=false (YES in step S22), the process advances to step S24.

The CPU 2201 further checks in step S23 if chk_02==true. If chk_02=false (NO in step S23), the process advances to step S34; if chk_02=true (YES in step S23), the process advances to step S45.

In step S24, the CPU 2201 acquires frame n having a frame interval F01 from x. The CPU 2201 checks if sum ≧n (step S25). If sum <n (NO in step S25), the process advances to step S26; if sum ≧n (YES in step S25), the process advances to step S27.

In step S26, the CPU 2201 sets chk_01=true. The process then advances to step S34.

In step S27, the CPU 2201 further acquires frame n_1 having a frame interval F01=F01+cnt_01*Δf from x (step S27). The CPU 2201 then checks if sum >n_1 (step S28). If sum >n_1 (YES in step S28), the process advances to step S29; if sum <n_1 (NO in step S28), the process advances to step S30.

In step S29, the CPU 2201 groups frames between n to n_1. The process then advances to step S31.

On the other hand, in step S30 the CPU 2201 groups frames between n to sum. The process then advances to step S31.

In step S31, the CPU 2201 generates an index frame from the grouped frames by index frame generation processing. Details of the index frame generation processing (step S31) will be described later.

After the index frame is generated from the grouped frames (step S31), the CPU 2201 respectively increments the processing count cnt_01 and the number i of generated index frames (step S32).

The CPU 2201 then checks if the total number i of generated index frames is equal to the displayable index frame count I. If i≠I (NO in step S33), the process advances to step S34; if i=I (YES in step S33), the process advances to step S45.

The operation of the latter half of the index screen creation processing will be described below with reference to FIG. 24. The CPU 2201 checks in step S34 if chk_02==false. If chk_02=true (NO in step S34), the process advances to step S35; if chk_02=false (YES in step S34), the process advances to step S36.

The CPU 2201 further checks in step S35 if chk_01==true. If chk_01=true (YES in step S35), the process advances to step S45; if chk_01=false (NO in step S35), the process returns to step S22.

On the other hand, in step S36 the CPU 2201 acquires frame m having a frame interval F02 from x. The CPU 2201 checks if m>1 (step S37). If m≦1 (NO in step S37), the process advances to step S47; if m>1 (YES in step S37), the process advances to step S38.

In step S47, the CPU 2201 sets chk_02=true, and the process returns to step S22.

On the other hand, in step S38 the CPU 2201 acquires frame m_1 having a frame interval F02=F02−cnt_02*Δf from x.

The CPU 2201 then checks if m_1≧1 (step S39). If m_1≧1 (YES in step S39), the process advances to step S40; if m_1<1 (NO in step S39), the process advances to step S41.

In step S40, the CPU 2201 groups frames between m and m_1. The process then advances to step S42.

In step S41, the CPU 2201 groups frames between 1 and m. The process then advances to step S42.

In step S42, the CPU 2201 generates an index frame from the frames grouped in step S40 or S41 by index frame generation processing. Details of the index frame generation processing (step S42) will be described later.

After the index frame is generated from the grouped frames (step S42), the CPU 2201 respectively increments the processing count cnt_02 and the number i of generated index frames (step S43).

The CPU 2201 then checks if the total number i of index frames generated so far is equal to the displayable index frame count I. If i≠I (NO in step S44), the process returns to step S22; if i=I (YES in step S44), the process advances to step S45.

In step S45, the CPU 2201 sorts the focused frame and the generated index frames in the frame order. In step S46, the CPU 2201 creates an surveying index screen as an output screen.

With the aforementioned processes, the index screen creation processing is complete, and the created index screen returns to the main sequence of the moving image display apparatus 2100, thus displaying the created screen on the display 2101.

(Index Frame Generation Processing)

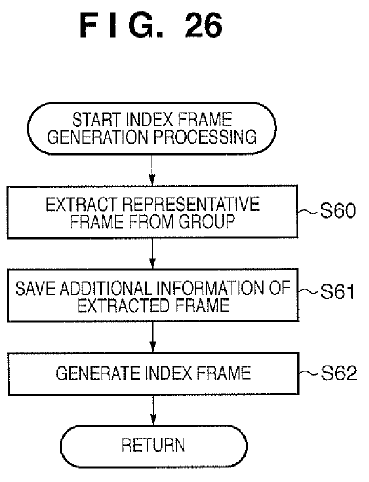

The index frame generation processing (steps S31 and S42) in this embodiment will be described below with reference to FIG. 26. FIG. 26 is a flowchart showing the sequence of the index frame generation processing.

Upon starting the index frame generation processing, the CPU 2201 extracts (acquires) a representative frame from the group (step S60). In this embodiment, as a representative frame of the group, a rearmost frame of the group is extracted. Of course, a start frame of the group, a frame selected by an image processing technique, a chapter frame recorded in advance in the moving image data, or the like may be preferentially extracted as a representative frame.

The CPU 2201 holds additional information of the extracted frame (step S61), and generates an index frame based on the held information (step S62). With the above processes, the index frame generation processing is complete, and that result returns to the source process.

As described above, the arrangement according to this embodiment executes acceptance processing for accepting selection of a focused frame (first frame) included in a moving image, and acquires a plurality of index frames (second frames) from frames at least one of ranges before and after the focused frame. Then, the arrangement executes display control processing for displaying a thumbnail of the focused frame and those of the plurality of index frames on the display 2101. Note that the moving image display apparatus 2100 acquires the index frames to broaden the frame interval between neighboring ones of the focused frame or the plurality of index frames as the neighboring frames are separated farther away from the focused frame.

For this reason, according to the arrangement of this embodiment, since the index frames used to survey a moving image content are displayed according to selection of a moving image frame, the user can easily recognize a general sequence of the moving image content. Since the interval near the focused frame position of the index frames is set to be narrow and that farther away from the focused frame position is set to be broad, the user can recognize the sequence of the moving image at different frame intervals. The user can finely confirm frames near the focused frame of interest, and can confirm a rough change in moving image at a position far away from the focused frame, thus easily finding out a desired scene. Therefore, the user can recognize the contents of the entire moving image data by a simple operation.

The moving image display apparatus 2100 displays a scroll area corresponding to the time axis of the moving image on the display 2101, and displays the focused frame position on the display 2101 while scrolling that position on the scroll area in response to a user's scroll operation. Then, a frame corresponding to the focused frame position is accepted as selection of the focused frame in response to the user's scroll operation. Hence, the user can recognize the contents of the overall moving image data by only a simple scroll operation.

The moving image display apparatus 2100 acquires the index frames so that the frame interval of neighboring index frames becomes multiples of a distance between the focused frame and the index frame that neighbors the focused frame. In this way, since the index frames are regularly acquired, the user can recognize the contents of the entire moving image data by a simple operation.

The moving image display apparatus 2100 groups frames included in the moving image to a plurality of groups, and acquires representative frames from these groups as index frames. In this manner, since the index frames are representative frames of the respective groups, the user can easily recognize the contents of the overall moving image data with reference to thumbnails of the index frames.

The moving image display apparatus 2100 controls to play back the moving image from the focused frame in response to a user's instruction. For this reason, the user can confirm the contents by playing back the moving image from a desired frame.

The moving image display apparatus 2100 updates the surveying index display contents in turn upon movement of the focused frame. In this way, the user can recognize the rough sequence of the moving image data more easily and quickly than a case in which moving image frames are simply displayed one by one.

### Fifth Embodiment

The fifth embodiment of the present invention will be described in detail hereinafter with reference to the drawings. This embodiment can output a surveying index display created by the index screen creation processing together with a scroll display of moving image frames unlike in the fourth embodiment.

A system arrangement view and hardware block diagram of this embodiment are the same as those in the fourth embodiment described using FIGS. 17 and 18. A functional block diagram of this embodiment is the same as that in the fourth embodiment described using FIG. 19. An operation input device used to operate a moving image display apparatus 2100 of this embodiment is the same as that in the fourth embodiment described using FIG. 20. The sequence of the main processing and surveying index display processing sequence of the moving image display apparatus 2100 of this embodiment are the same as those in the fourth embodiment described with reference to FIGS. 21 to 26. In this embodiment as well, the same reference numerals denote the same components throughout the drawings unless otherwise specified, and a repetitive description thereof will be avoided.

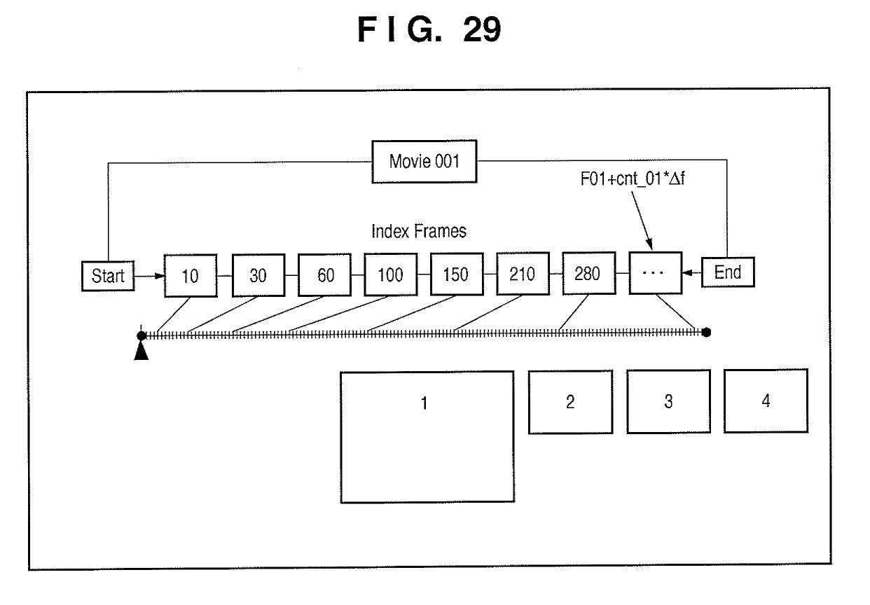

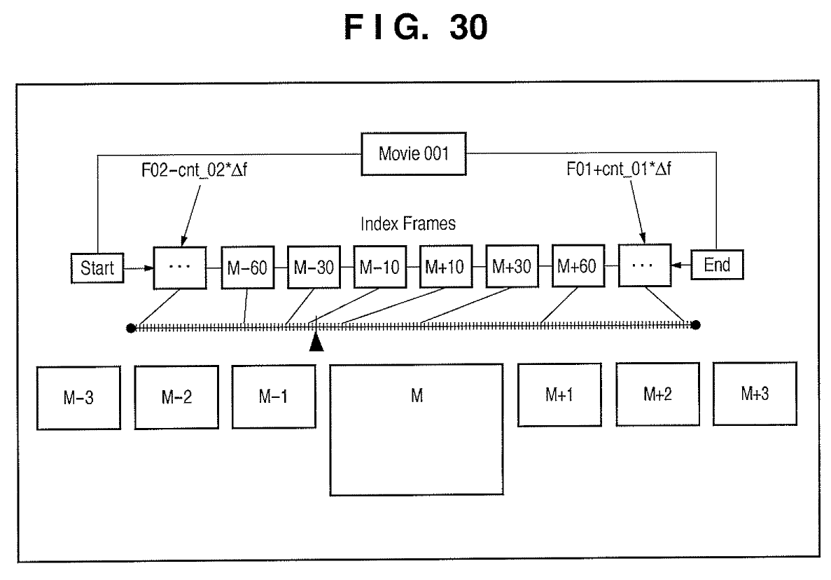

FIGS. 29 and 30 show examples of a screen display to be output in this embodiment. FIG. 29 shows an initial index display when the moving image display apparatus 2100 starts a surveying index display. As a focused frame scrolls, the index display shown in FIG. 29 is sequentially updated to that shown in FIG. 30. The user selects a frame displayed at that time by pressing an OK button 2403 of a remote controller 2400, thus playing back a moving image from the selected frame.

This embodiment has exemplified the case in which the scroll display of moving image frames is displayed on a lower portion of the display screen, and the surveying index display is displayed on an upper portion of the display screen. However, the present invention is not limited to this. In the scroll display of moving image frames, in order to distinguish the focused frame from other frames, the focused frame is displayed to have a size larger than other frames. However, the focused frame may be distinguished from other frames using a different color, shape, or the like when it is displayed.

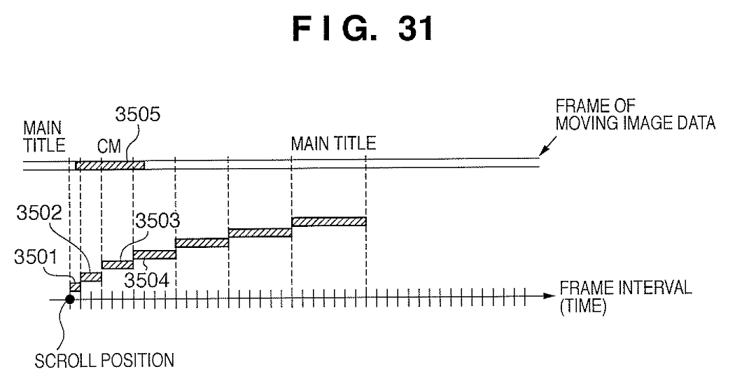

In this embodiment, in addition to the scroll display of moving image frames, the index display, which is sequentially updated according to the scroll display position, is simultaneously displayed as a surveying display. In this way, the operability for scroll operations upon retrieving a moving image frame can be improved. This will be briefly explained using FIG. 31. FIG. 31 is a view for explaining improvement of operability in moving image frame retrieval.

For example, when the focused frame in moving image data is located at a position shown in FIG. 31, and a CM exists to have an illustrated duration 3505, the CM can be easily skipped using the moving image display apparatus 2100 of this embodiment. Reference numerals 3501 to 3504 denote groups which are grouped by a frame grouping unit 2306 and have different frame intervals. Index frames to be extracted from the respective groups are generated by an index frame generation unit 2305, and are rearmost frames of the respective groups in this embodiment.

At this time, the user can confirm with reference to the index frame of the frame group 3501 that this frame range is still in the CM. Furthermore, the user can also confirm with reference to the index frame of the group 3502 that this frame range is still in the CM. Likewise, the user can confirm that the frame range of the group 3503 is also in the CM. Then, the user can confirm with reference to the index thumbnail of the group 3504 that the CM has already ended and a main title has started. Therefore, the user can determine that frames between the frame groups 3501 to 3503 can be quickly skipped by scrolling.

As described above, according to this embodiment, the index frames are displayed at different frame intervals (granularities) so that frames near the focused frame are displayed at fine frame intervals and those farther away from the focused frame are displayed at coarse frame intervals. In this way, the user can easily determine the frame range that can be skipped. When the index frames are displayed at only fine frame intervals, the number of times of determination until skip determination increases. Conversely, when the index frames are displayed at only coarse frame intervals, the division between the CM and main title cannot often be detected. By contrast, in this embodiment, upon retrieving moving image data, if a desired moving image scene is not located near the focused frame, index frames can be displayed at different intervals (granularities). Therefore, the user can skip more frames by a smaller number of times of determination.

The moving image display apparatus 2100 displays, on a display 2101, thumbnails of a predetermined number of continuous frames from those at least one of before and after the focused frame. For this reason, the user can select the focused frame more easily and appropriately by confirming those before and after the focused frame.

As described above, according to this arrangement, the user can recognize the rough sequence of moving image data easily and quickly by exploiting the index display which is sequentially updated.

This arrangement simultaneously displays the index display, which is sequentially updated in synchronism with the scroll display position as a surveying display upon scroll display of moving image frames. With the surveying display, the operability for scroll operations upon retrieving a moving image frame can be improved. At this time, in this arrangement, frames are grouped to have different frame intervals in proportion to the distances from the scroll position, and index frames are extracted from these groups. As a result, the user can recognize the sequence of the moving image at different frame intervals (granularities). That is, if a desired moving image scene is not located near the focused frame, the user can determine how far moving image frames can be skipped by scrolling using the surveying index display displayed at different frame intervals (granularities).

Therefore, according to the present invention, a technique that allows the user to recognize the contents of entire moving image data by a simple operation can be provided.

### Other Embodiments

The embodiments of the present invention have been explained in detail. The present invention can adopt embodiments in the forms of, for example, a system, apparatus, method, program, storage medium, and the like. More specifically, the present invention may be applied to either a system constituted by a plurality of devices, or an apparatus consisting of a single device.

Note that the objects of the present invention can also be achieved by directly or remotely supplying a program that implements the functions of the aforementioned embodiment to a system or apparatus, and reading out and executing the supplied program code by a computer of that system or apparatus.

Therefore, the program code itself installed in a computer to implement the functional processing of the present invention using the computer is included in the technical scope of the present invention. That is, the present invention includes the computer program itself for implementing the functional processing of the present invention.

In this case, the form of program is not particularly limited, and an object code, a program to be executed by an interpreter, script data to be supplied to an OS, and the like may be used as long as they have the functions of the program.

A recording medium used to supply the program includes, for example, the following media. That is, a flexible disk, hard disk, optical disk, magneto-optical disk, MO, CD-ROM, CD-R, CD-RW, magnetic tape, nonvolatile memory card, ROM, DVD (DVD-ROM, DVD-R), and the like are included.

As another program supply mode, the following mode may be used. That is, in one mode, the user establishes a connection to a homepage on the Internet using a browser on a client computer, and downloads the computer program according to the present invention or a compressed file including an automatic installation function from the homepage onto a recording medium such as an HD or the like. Also, the program code that forms the program of the present invention may be segmented into a plurality of files, which may be downloaded from different homepages. That is, the present invention includes a WWW server which makes a plurality of users download program tiles required to implement the functional processing of the present invention by their computers.

Also, the following supply mode may be used. That is, a computer-readable storage medium such as a CD-ROM or the like, which stores the encrypted program of the present invention, is delivered to the users. The users who have cleared a predetermined condition are allowed to download key information used to decrypt the encrypted program from a homepage via the Internet. The users execute the encrypted program using the downloaded key information to install the program on their computers, thus implementing the arrangement according to the present invention. Such supply mode is available.

The functions of the aforementioned embodiments can be implemented when the computer executes the readout program. Furthermore, the following embodiment is also assumed. That is, an OS or the like running on the computer executes some or all actual processes based on an instruction of that program, thereby implementing the functions of the aforementioned embodiments.

Furthermore, the functions of the aforementioned embodiments can also be implemented based on an instruction of the program read out from the recording medium after the program is written in a memory equipped on a function expansion board or a function expansion unit, which is inserted in or connected to the computer. That is, a CPU equipped on the function expansion board or function expansion unit executes some or all of actual processes, which implement the functions of the aforementioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-228285, filed on Sep. 3, 2007, and Japanese Patent Application No. 2007-228286, filed on Sep. 3, 2007, which are hereby incorporated by reference herein in their entirety.

What is claimed is:

1. A display control apparatus for displaying an image included in an array of images on a display unit, comprising:
a display control unit adapted to display a scroll area corresponding to an order of images in the array on the display unit;
an accepting unit adapted to accept selection of a first image included in the array in response to a user's scroll operation; and
an acquisition unit adapted to acquire a plurality of second images from images in at least one of ranges before and after the first image,
wherein said display control unit displays the first image and the plurality of second images on the display unit, and
said acquisition unit switches an acquisition method of the second images based on a characteristic of the scroll operation.

2. The apparatus according to claim 1, wherein said acquisition unit switches the acquisition method of the second images based on a position of the first image in the array, which is accepted by said accepting unit.

3. The apparatus according to claim 2, wherein said acquisition unit acquires a predetermined number of second images at an equal interval from images in at least one of the ranges before and after the first image.

4. The apparatus according to claim 2, further comprising a grouping unit adapted to group the images included in the array into a plurality of groups,
wherein said acquisition unit acquires representative images from the groups as the second images.

5. The apparatus according to claim 4, wherein said acquisition unit acquires, as the second images, images which exist in a scroll direction of images before or after the first image.

6. The apparatus according to claim 5, wherein when a scroll speed is less than a predetermined threshold, said acquisition unit acquires the second images from the group that neighbors the first image.

7. The apparatus according to claim 1, wherein said display control unit displays positions of the first image and the second images in the array on the display unit.

8. The apparatus according to claim 1, wherein the images included in the array are frames of a moving image.

9. The apparatus according to claim 8, further comprising a control unit adapted to control to play back the moving image from the first image in response to a user's instruction.

10. A method of controlling a display control apparatus for displaying an image included in an array of images on a display unit, comprising the steps of:
displaying a scroll area corresponding to an order of images in the array on the display unit;
accepting selection of a first image included in the array in response to a user's scroll operation;
acquiring a plurality of second images from images in at least one of ranges before and after the first image; and
displaying the first image and the plurality of second images on the display unit,
wherein in the step of acquiring the second images, an acquisition method of the second images is switched based on a characteristic of the scroll operation.

11. A display control apparatus for displaying thumbnails of frames included in a moving image on a display unit, comprising:
an accepting unit adapted to accept selection of a first frame included in the moving image;
an acquisition unit adapted to acquire a plurality of second frames from frames in at least one of ranges before and after the first frame; and
a display control unit adapted to display a thumbnail of the first frame and thumbnails of the plurality of second frames on the display unit,
wherein said acquisition unit acquires the second frames to broaden a frame interval between neighboring frames of the first frame or the plurality of second frames as the neighboring frames are separated farther away from the first frame.

12. The apparatus according to claim 11, wherein said display control unit displays a scroll area corresponding to a time axis of the moving image on the display unit, and displays a frame position to be focused on the display unit by scrolling the frame position to be focused on the scroll area in response to a user's scroll operation, and
said accepting unit accepts a frame corresponding to the frame position to be focused as the first frame in response to the scroll operation.

13. The apparatus according to claim 11, wherein said acquisition unit acquires the second frames so that a frame interval between the neighboring second frames becomes a multiple of a distance between the first frame and the second frame which neighbors the first frame.

14. The apparatus according to claim 11, further comprising a grouping unit adapted to group frames included in the moving image into a plurality of groups,
wherein said acquisition unit acquires representative frames from the groups as the second frames.

15. The apparatus according to claim 11, wherein said display control unit further displays thumbnails of a predetermined number of continuous frames from frames in at least one of the ranges before and after the first frame.

16. The apparatus according to claim 11, further comprising a control unit adapted to control to play back the moving image from the first frame in response to a user's instruction.

17. A method of controlling a display control apparatus for displaying thumbnails of frames included in a moving image on a display unit, comprising the steps of:
accepting selection of a first frame included in the moving image;
acquiring a plurality of second frames from frames in at least one of ranges before and after the first frame; and
displaying a thumbnail of the first frame and thumbnails of the plurality of second frames on the display unit,
wherein in the step of acquiring the second frames, the second frames are acquired to broaden a frame interval between neighboring frames of the first frame or the plurality of second frames as the neighboring frames are separated farther away from the first frame.

18. A program stored in a computer-readable recording medium to make a computer function as a display control apparatus according to claim 1.

19. A computer-readable recording medium storing a program according to claim 18.
